(19) United States
(12) Patent Application Publication
(10) Pub. No.: US 2026/0290074 A1
(43) Pub. Date: Sep. 24, 2026

(54) SYSTEM

(71) Applicant: SoftBank Group Corp., Tokyo (JP)

(72) Inventor: Mayumi HADANO, Tokyo (JP)

(73) Assignee: SoftBank Group Corp., Tokyo (JP)

(21) Appl. No.: 19/561,769

(22) Filed: Mar. 10, 2026

(30) Foreign Application Priority Data
Mar. 19, 2025 (JP) 2025-044510

(51) Int. Cl. G06V 40/16; G06F 40/211; G06N 3/0475; G10L 15/16

(52) U.S. Cl. CPC G06V 40/174; G06F 40/211; G06N 3/0475; G10L 15/16

(57) ABSTRACT

A system includes a processor that is configured to receive input information from a user, analyze the input information by using natural language processing techniques and evaluate an intention of the user and a degree of respect toward a counterpart, generate, based on a result of the evaluation, a prompt for instructing a generative artificial intelligence model to convert the input information into an expression that respects the counterpart, track a change in an emotion of the user by using emotion analysis techniques to analyze the emotion of the user and adjust the expression of respect based on the change in the emotion, and output a result of the conversion.

### CROSS-REFERENCE TO RELATED APPLICATION

This application is based on and claims priority under 35 USC 119 from Japanese Patent Application No. 2025-044510 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In interpersonal and organizational communication, users often wish to convey their honest opinions, including criticism or disagreement, while maintaining an appropriate level of respect toward a counterpart such as a superior, a colleague, a subordinate, or a client. However, many users lack the skill or situational awareness to appropriately adjust their expressions, which can result in misunderstandings, deterioration of relationships, or escalation of conflicts. Conventional communication support tools typically focus on simple text correction or sentiment indication and do not sufficiently analyze the user's intention, the degree of respect required for the counterpart, and dynamic changes in the user's emotional state. As a result, such tools cannot reliably generate expressions that appropriately balance honesty and respect, or flexibly adjust the level of respectful tone in response to changes in the user's emotion over time. Therefore, there is a need for a system capable of receiving a user's input, deeply analyzing the intention and the required degree of respect, tracking emotional changes of the user, and generating or supporting the generation of expressions that respect the counterpart in a more stable and context-appropriate manner.

### SUMMARY

To solve the above-described problems, the present invention provides a system comprising a processor, wherein the processor is configured to receive input information from a user, analyze the input information by using natural language processing techniques, and evaluate an intention of the user and a degree of respect toward a counterpart. The processor is further configured to generate, based on a result of the evaluation, a prompt for instructing a generative artificial intelligence model to convert the input information into an expression that respects the counterpart, thereby enabling consistent and controllable generation of respectful expressions. In addition, the processor is configured to track a change in an emotion of the user by using emotion analysis techniques to analyze the emotion of the user and to adjust the expression of respect based on the change in the emotion, so that the output can reflect the user's emotional dynamics while maintaining an appropriate respectful tone. The processor is also configured to perform processing in consideration that the input information includes an honest opinion of the user and a relationship with the counterpart, thereby tailoring the degree and style of respect to the specific interpersonal context. Furthermore, the processor is configured to integrate the system into a tool for organizational management or to use the system as an automatic response program of a communication tool, which allows the invention to be applied broadly in corporate, educational, and other communication environments.

The term “input information” refers to information input by a user, including at least a textual message expressing the user's opinion or intention and optionally additional context such as a description of a relationship with a counterpart.

The term “natural language processing techniques” refers to computational methods for analyzing and processing human language, including but not limited to tokenization, part-of-speech tagging, syntactic parsing, semantic analysis, intent detection, and sentiment analysis.

The term “intention of the user” refers to a semantic objective or communicative purpose that the user aims to convey through the input information, such as agreement, disagreement, criticism, suggestion, or inquiry.

The term “degree of respect toward a counterpart” refers to a level or intensity of politeness, deference, or consideration that is appropriate for the person to whom the message is directed, based on factors such as hierarchical relationship, social distance, and communication context.

The term “counterpart” refers to a person or party who is the intended recipient or subject of the user's message, such as a superior, subordinate, colleague, client, or other communication partner. The term “prompt” refers to a text or structured instruction generated by the processor and provided as input to a generative artificial intelligence model in order to guide the model to produce a desired output, including an expression that respects the counterpart.

The term “generative artificial intelligence model” refers to a machine learning model, such as a neural network-based language model, that is capable of generating text or other content in response to a given prompt or input.

The term “expression that respects the counterpart” refers to a textual expression generated by the system that conveys the user's intention while maintaining a polite, considerate, and context-appropriate tone toward the counterpart.

The term “emotion analysis techniques” refers to computational methods for detecting, classifying, or quantifying a user's emotional states from input data, including but not limited to text-based sentiment analysis, affective state classification, and temporal tracking of emotional changes.

The term “change in an emotion of the user” refers to a temporal variation in the user's emotional state, such as a shift from calm to anger, or from frustration to neutrality, as inferred from one or more pieces of input information over time.

The term “respectful expression” refers to an expression that has been adjusted or generated so as to reflect an appropriate degree of respect toward the counterpart, in view of the user's intention, emotional state, and relationship with the counterpart.

The term “honest opinion of the user” refers to a content of the input information that directly reflects the user's true thoughts, feelings, or evaluations, including criticism or disagreement, without intentional masking or distortion.

The term “relationship with the counterpart” refers to a description or classification of the interpersonal or hierarchical relation between the user and the counterpart, such as superior-subordinate, colleague, client, or friend.

The term “tool for organizational management” refers to a software or system used within an organization to support management activities, including but not limited to human resources management, performance evaluation, internal communication, and conflict resolution.

The term “automatic response program of a communication tool” refers to a software component integrated into a communication platform, such as email, chat, or messaging software, that automatically generates or proposes responses based on user input without requiring manual drafting of full messages by the user.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

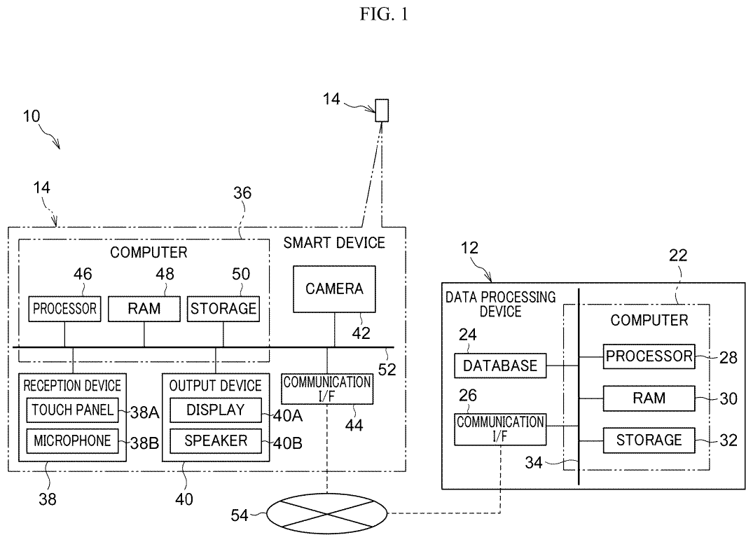

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

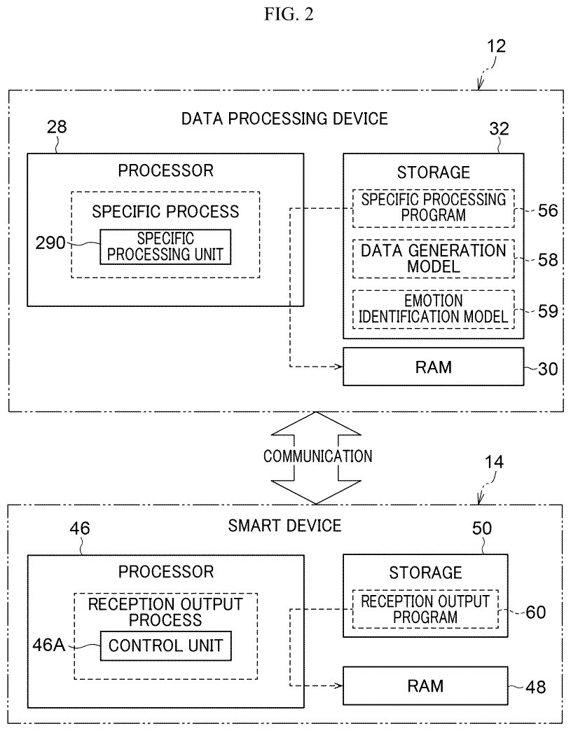

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented communication support systems primarily focus on rewriting or filtering user messages based on keyword substitution, rule-based politeness dictionaries, or static templates. Such systems typically treat user input as a flat text string and do not explicitly model the underlying relationship between the user and the counterpart (for example, superior, peer, or subordinate), nor do they systematically encode this relationship and the user's internal opinion into a machine-usable representation for downstream processing. As a result, the generated suggestions often fail to adapt tone, formality, and communicative strategy to context, thereby reducing their practical usefulness in real organizational environments.

Furthermore, in many existing architectures, a natural language generation engine is invoked in an ad-hoc manner: the same generic prompt sentence is repeatedly sent to a generative model, without structured integration of user-specific parameters such as the user's honest opinion and interpersonal relationship. This leads to inconsistent outputs, makes it difficult to control what type of communication method is produced, and impedes reproducibility and maintainability from a software engineering perspective. In addition, the communication between user devices and server-side generation components frequently lacks a clearly defined, structured data format, which complicates interface design, hampers interoperability, and can introduce security and reliability issues when unstructured text is transmitted and interpreted.

Thus, there is a need for an improved computer-implemented technique that (i) acquires user opinion content and relationship information in a consistent way at the terminal, (ii) converts such information into a structured data representation, (iii) systematically embeds that information into a prompt sentence template for a generative AI model, and (iv) returns the model's output to the user through a well-defined, structured communication path. Such a technique should provide a repeatable, controllable, and context-sensitive generation of communication methods, thereby improving the functioning of the overall computer system, including data structures, network interfaces, and model invocation logic, rather than merely automating human mental processes.

The specific processing by the specific processing unit 290 of the data processing device 12 in Example 1 is realized by the following means.

The present invention provides a server comprising a processor configured to receive, via a communication interface, structured information representing user input including an opinion and a relationship between the user and a counterpart, to generate, based on the structured information, a prompt sentence in a natural language by inserting the opinion and the relationship into a predefined prompt template, to input the prompt sentence to a generative AI model executing on the server or on an external computation resource, to obtain from the generative AI model a generated natural language expression representing an appropriate communication method corresponding to the opinion and the relationship, to convert the generated natural language expression into a structured information format, and to transmit the structured information format to a user-side apparatus using a secure communication protocol. This enables improved computer operation by enforcing a consistent, machine-readable representation of user opinion and relationship data, providing deterministic construction of model prompt sentences, ensuring reliable and secure data exchange between the server and user-side apparatuses, and allowing the generative AI model to produce context-sensitive communication guidance in a manner that enhances the controllability, interoperability, and technical performance of the communication support system.

The term “system” refers to an arrangement of one or more computing devices and communication components that cooperate to perform information processing operations as recited in the claims.

The term “processor” refers to a hardware processing unit, such as a central processing unit, a graphics processing unit, or any other arithmetic and logic processing circuitry, that executes instructions to perform the claimed functions.

The term “user” refers to a human operator or an entity that provides input information to the system and receives output information from the system.

The term “input information” refers to digital data provided by the user, including at least an opinion of the user and a relationship between the user and a counterpart that is a target of the opinion.

The term “opinion” refers to a textual representation of the user's subjective view, assessment, or feeling regarding a situation, proposal, or person.

The term “relationship” refers to information indicating a social, hierarchical, or functional connection between the user and the counterpart, such as superior, peer, subordinate, client, or colleague.

The term “structured information format” refers to a machine-readable data representation having an explicit structure, such as key-value pairs or fields, which can be parsed and processed by a computer program.

The term “secure communication method” refers to a communication protocol or mechanism that provides confidentiality, integrity, and, optionally, authentication for data transmitted between devices, such as an encrypted network protocol.

The term “information processing apparatus” refers to a computing device, such as a server, that includes at least one processor and memory, and that executes software to perform data analysis, prompt generation, model invocation, and output processing.

The term “user-side apparatus” refers to a computing device operated by or on behalf of the user, such as a terminal or client device, that transmits input information to the information processing apparatus and receives output information from the information processing apparatus.

The term “prompt sentence” refers to a natural language instruction text that is provided as input to a generative AI model to cause the generative AI model to perform a specific generation task.

The term “predefined template of the prompt sentence” refers to a stored natural language pattern or skeleton that includes fixed textual components and one or more insertion positions into which variable elements, such as the opinion and the relationship, are embedded.

The term “generative AI model” refers to a machine learning model configured to generate natural language or other content in response to input data, including at least a large-scale language model trained on textual data.

The term “natural language expression” refers to text in a human language that is generated by the generative AI model and is interpretable by a human reader.

The term “appropriate communication method” refers to a communication strategy, style, or set of example sentences that is adapted to the user's opinion and the relationship with the counterpart, and that is intended to be respectful and suitable for interpersonal interaction.

The term “display device” refers to an output component capable of visually presenting text or other information to the user, such as a liquid crystal display, an organic light-emitting diode display, or another graphical output unit.

The term “communication software” refers to application software that enables exchange of messages or information between users, such as messaging applications, email clients, or collaboration tools.

The term “automatic response function” refers to a software-controlled operation that generates and outputs responses to received messages without manual drafting by a human user, based at least in part on automated processing.

The term “management tool” refers to software or a software-assisted system used to support organizational operations, including personnel management, task coordination, or communication management within an organization.

In one embodiment, the system includes at least one server, at least one terminal, and a communication network connecting them. The server includes a processor, a main memory, a non-volatile storage device, and a network interface. The terminal includes a processor, a main memory, a display device, an input interface such as a hardware keyboard or software keyboard, and a communication interface such as a wireless communication module. The server and the terminal execute software components that implement the functions described below.

The terminal executes a client application implemented, for example, as a web application using an execution environment such as a web browser, or as a native mobile application running on an operating system such as a mobile operating system or a desktop operating system. The terminal displays, on the display device, a graphical user interface including at least two text input fields: an input field for a user opinion and an input field for a relationship between the user and a counterpart. The user operates the terminal and inputs free-form natural language sentences into these fields.

The terminal converts the textual input into a structured information format. The terminal uses a data serialization library, such as a JSON-handling library provided by a programming platform, to encode the opinion and the relationship as key-value pairs. For example, the terminal constructs an internal object having keys “opinion” and “relationship,” and serializes this object into a structured string. The terminal stores the structured string in the main memory and transmits it to the server using a secure communication protocol such as an encrypted transport protocol over a network stack provided by the operating system.

The server receives the structured string via the network interface, and the processor of the server stores the received data in the main memory. The server executes server-side software, such as an application framework, that parses the structured string using a parser library and converts it into an internal data structure such as a map or dictionary in memory. The server thereby obtains, in a machine-readable format, the opinion text and the relationship text.

The server generates a prompt sentence to be input to a generative AI model. The server stores in the non-volatile storage device one or more predefined templates for prompt sentences. A template is a natural language pattern including fixed segments and placeholders for variable segments. The server retrieves an appropriate template into memory and inserts the opinion and the relationship into the placeholders by string concatenation or formatting operations. For example, the server generates a prompt sentence such as:
“You are a communication coach in a corporate environment.

### Task:

Based on the user's honest opinion and the relationship with the counterpart, use an appropriate tone (considering hierarchy and culture) and propose an appropriate communication method.

### Requirements:

Provide specific example sentences the user can say.
Avoid offensive or insulting expressions.
Keep the length within 200 words.
Honest opinion: “I think his proposal is wrong.”
Relationship: “He is my boss.””

In another example, the server generates a prompt sentence such as:
“Based on the following information, generate a polite and effective message the user can send by email.
Honest opinion: “I feel overwhelmed by the amount of work she assigns to me.”
Relationship: “She is my direct supervisor.”

### Please Output:

1. A brief explanation of the communication strategy.
2. A sample email text the user can actually send.”

By encoding the user's opinion and relationship into a structured format at the terminal, and by systematically mapping that structure into predefined prompt templates at the server, the system ensures that data is consistently formatted and that the generative AI model receives a well-defined and reproducible instruction. This structured interface between user input and model invocation improves the reliability and predictability of model behavior, as compared to ad-hoc, unstructured textual interactions.

The server invokes a generative AI model implemented as a neural network. In one embodiment, the generative AI model is a transformer-based language model having multiple layers of self-attention and feed-forward sublayers. The model parameters include learned weight matrices for query, key, and value projections in each attention layer, as well as weight matrices and bias vectors in fully-connected layers. The model is trained, prior to deployment, on a large corpus of natural language text using a language modeling objective that minimizes a loss function such as cross-entropy between predicted token distributions and actual observed tokens. During training, the server or an external computation resource performs backpropagation to compute gradients of the loss with respect to each weight parameter, and updates the parameters using an optimization algorithm such as stochastic gradient descent with adaptive learning rates. The training process may include regularization techniques, such as dropout, and data augmentation techniques, such as random masking of tokens.

The server uses a client library to send the prompt sentence to the generative AI model. In one configuration, the model executes on the same physical server or on a cluster accessible through an internal interface. In another configuration, the model executes on a remote computation resource provided as a cloud-based inference service. In both cases, the server constructs a model input structure that includes the prompt sentence, a maximum output length, a temperature parameter controlling sampling randomness, and a top-k or top-p sampling parameter specifying how token probabilities are truncated. These parameters are set to values that balance diversity of the generated text with consistency of politeness and respect.

The generative AI model receives the prompt sentence and converts each token into a vector embedding using an embedding matrix. The model propagates the embeddings through the transformer layers, computing attention weights based on learned similarity measures in a high-dimensional space. At each generation step, the model computes a probability distribution over the next token using a softmax function applied to the output of the last layer. The system selects a token according to the sampling parameters and appends it to the output sequence. This process continues until an end-of-sequence token is produced or the maximum length is reached. Because the prompt sentence encodes both the opinion and the relationship in a structured and explicit manner, the attention mechanism can more reliably associate relationship cues (e.g., “boss,” “junior colleague”) with politeness strategies and phrasing patterns learned during training.

The server receives the generated tokens from the generative AI model and concatenates them into a natural language expression. The server may perform post-processing, such as trimming whitespace, enforcing character limits, or applying a filter to detect and remove unwanted expressions based on pattern matching or a separate classifier. The server then converts the resulting text into a structured information format, again using a serializer library to produce a representation with a key such as “proposal” associated with the generated text. The server transmits this structured representation to the terminal using the secure communication protocol.

The terminal receives the structured representation and parses it using a parser library. The terminal extracts the generated natural language expression and displays it on the display device as a suggested communication method. The user can read, copy, or adapt the suggested text in real-world communication. Because the suggestion is computed as a function of both the user's internal opinion and the formalized relationship, the result can be more context-appropriate than simple template-based expansions.

The server uses the structured interface and prompt-template mechanism to improve computer performance in several technical aspects. First, the server reduces unnecessary network payload by transmitting compact structured representations instead of large, unstructured text blocks that require additional parsing or normalization at each step. Second, the server improves processing speed by decoupling the application logic into modules that handle parsing, template substitution, model invocation, and post-processing, each operating on defined data structures. This modularity allows efficient caching of templates and re-use of parsing results, reducing repeated computation. Third, by enforcing that the model input always follows a standardized prompt sentence structure, the server reduces variability and error rates in downstream parsing of model outputs, which can be measured as a decrease in malformed responses or out-of-scope outputs.

The server applies non-traditional, AI-specific processing rules that differ from typical human-written correspondence. For instance, the server can maintain a library of multiple prompt templates that are selected based on metadata contained in the structured information, such as a role indicator (“superior,” “peer,” “subordinate”) or a communication channel indicator (“email,” “chat,” “meeting”). The server can compute a template selection score using a deterministic rule or a lightweight classifier model that takes as input features extracted from the structured information, such as the length of the opinion text, the sentiment polarity value, or an urgency flag. This rule-based and model-augmented selection process is executed entirely in the server's processor, using numerical operations over machine-readable features, thereby enabling algorithmic control over how the generative AI model is prompted.

In another embodiment, the server includes an emotion analysis module that computes sentiment-related features for the opinion text. The server can use a separate neural network classifier that maps token embeddings into a sentiment vector indicating, for example, degrees of anger, sadness, or anxiety. The classifier is trained using a supervised learning method with a labeled dataset, and uses a loss function such as categorical cross-entropy. The server records the sentiment vector along with the opinion and relationship in the structured information, and modifies the prompt sentence to include guidance for emotional modulation, such as: “The user is frustrated; please maintain a calm and constructive tone while preserving the essential content of the opinion.” This explicit representation and controlled injection of sentiment features into the prompt sentence improves the accuracy and stability of emotionally appropriate responses, reducing cases where the model amplifies or misrepresents user emotions.

The terminal and the server cooperate to manage user data efficiently. The terminal performs initial validation of the input fields, such as length checks and character encoding normalization, before serialization. This pre-processing reduces the need for repeated error handling at the server side and thereby decreases processing time and memory usage on the server. On the server side, the structured information is stored in an indexed database as records containing fields for opinion, relationship, model parameters, and generated outputs. The server can perform aggregate analysis over this structured data to tune system parameters, such as choosing a default temperature or length for certain relationship categories, based on empirical error rates or user feedback. These optimizations directly improve the technical performance of the system, including throughput and output quality.

In one variation, the server executes the generative AI model locally using a hardware accelerator such as a graphics processing unit. The server loads the model parameters into memory once and keeps them resident, while successive prompt sentences are processed in batches. This batching improves computational efficiency by exploiting parallel execution of attention operations and matrix multiplications. The server schedules batch processing using a queue mechanism that groups incoming requests, thereby reducing per-request overhead and increasing overall processing speed measured as completed generations per second.

In another variation, the server supports multiple language models with different architectures or sizes, such as a large model for detailed guidance and a smaller model for quick, approximate feedback. The server selects an appropriate model instance based on criteria recorded in the structured information, such as a required response latency or a maximum allowed token count. The server thereby controls computational resource usage at runtime, balancing quality and speed according to structured parameters rather than static configuration. This dynamic model selection, driven by structured input and template metadata, is a technical mechanism that optimizes resource utilization.

The system can be integrated into different types of applications. In one implementation, the system is embedded in a management tool that runs on an enterprise platform. The terminal is a workstation client that employees use to input their opinions and relationships into the system. The server generates suggestions that are stored in a log associated with each interaction, and the log is accessible through an administrative interface that allows technical staff to monitor model behavior and adjust templates or parameters. In another implementation, the system is used as an automatic response function in communication software, where incoming messages and relationship metadata are converted into structured information and automatically processed by the server to generate draft responses that the user can approve or edit.

Across these embodiments, the server, the terminal, and the network cooperate to implement a series of concrete data transformations and control operations: raw user input is converted into structured fields, those fields are mapped into a standardized prompt sentence, the prompt sentence is processed by a trained neural network model under algorithmic control, the model's token outputs are post-processed and re-structured, and the final content is rendered on a display device. Because each step is defined in terms of specific data structures, algorithms, and hardware-software interactions, the system achieves improvements in computational efficiency, output consistency, and security that go beyond mere automation of human mental activity.

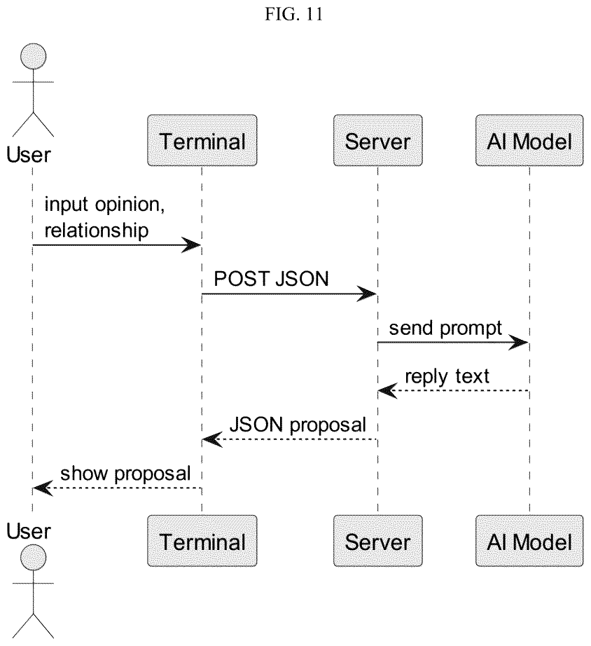

The following describes the processing flow using FIG. 11.

### Step 1:

The user operates the terminal and opens an application screen that displays at least two text input fields.

The user inputs natural language text representing an opinion and a relationship with a counterpart into the respective fields and presses a submit button.

The terminal receives keystroke events from the input interface, updates the text fields in real time, and stores the final contents as two string variables in memory.
Input: user's raw text for the opinion and relationship.
Output: in-memory string variables opinion_text and relationship_text within the terminal.

### Step 2:

The terminal converts the in-memory strings into a structured information format.

The terminal creates an internal data object with keys such as “opinion” and “relationship” and assigns the opinion_text and relationship_text as values.

The terminal uses a serialization function provided by a JSON library to transform the internal object into a JSON string.
Input: opinion_text and relationship_text strings.
Output: a JSON-formatted string representing a structured object, for example including fields “opinion” and “relationship.”

### Step 3:

The terminal sends the structured information to the server over a secure communication channel.

The terminal constructs an HTTPS request, sets headers including a content type for structured data, and embeds the JSON string into the request body.

The terminal uses the network stack and a client HTTP library to establish a TLS session and transmit the request bytes via a network interface.
Input: JSON-formatted string and a destination server address.
Output: an HTTPS request containing the structured information delivered to the server's network interface.

### Step 4:

The server receives the HTTPS request from the terminal and parses the structured information.

The server reads the request body from the network socket into a buffer in main memory and invokes a JSON parser to convert the JSON string into an internal data structure, such as a dictionary.

The server extracts the values associated with the “opinion” and “relationship” keys and stores them in separate variables.
Input: JSON-formatted string received over HTTPS.
Output: internal server-side variables opinion_value and relationship_value in a machine-usable structure.

### Step 5:

The server generates a prompt sentence by combining template text with the extracted opinion and relationship.

The server retrieves a predefined prompt template from storage, which includes fixed natural language instructions and placeholder positions.

The server performs string formatting or concatenation operations to insert opinion_value and relationship_value into the placeholders and constructs a full prompt sentence.
Input: opinion_value, relationship_value, and a stored prompt template.
Output: a complete prompt sentence string in natural language to be supplied to the generative AI model.

### Step 6:

The server prepares model input parameters for the generative AI model.

The server creates a model input structure including the prompt sentence, a maximum output length, a temperature value, and other generation parameters such as top-k or top-p values.

The server validates that the prompt length and parameters are within predefined limits and transforms them into the format required by the model interface or external model API.
Input: prompt sentence string and configuration values stored on the server.
Output: a structured model input object containing the prompt and numerical generation parameters.

### Step 7:

The server invokes the generative AI model using the prepared model input.

The server passes the prompt and parameters either to a locally hosted neural network process or to an external inference endpoint through an API call over HTTPS.

The generative AI model tokenizes the prompt sentence, converts tokens to embeddings, applies transformer layers with attention and feed-forward computations, and generates output tokens according to the provided parameters.
Input: model input object including the prompt sentence and generation parameters.
Output: a sequence of generated tokens representing a natural language expression of an appropriate communication method.

### Step 8:

The server post-processes the generated tokens and produces a final natural language expression.

The server converts the token sequence into a text string using a vocabulary mapping, removes extraneous control tokens, trims whitespace, and may apply filtering rules to remove disallowed patterns.

The server optionally formats the text to ensure it conforms to length constraints and readability requirements.
Input: generated token sequence from the generative AI model.
Output: a refined natural language expression string that describes an appropriate communication method for the given opinion and relationship.

### Step 9:

The server encodes the refined natural language expression into a structured information format for return to the terminal.

The server creates a response object with a key such as “proposal” and assigns the refined natural language expression as its value.

The server uses a JSON serialization function to transform this object into a JSON-formatted string suitable for transmission.
Input: refined natural language expression string.
Output: JSON-formatted string containing the generated communication proposal.

### Step 10:

The server sends the structured response back to the terminal over the secure communication channel.

The server constructs an HTTPS response, sets the content type to indicate structured data, and copies the JSON-formatted string into the response body.

The server writes the response to the network socket and completes the HTTPS transaction.
Input: JSON-formatted response string on the server.
Output: HTTPS response containing the structured proposal delivered to the terminal's network interface.

### Step 11:

The terminal receives the HTTPS response and parses the structured response.

The terminal reads the response body from the network stack into memory and invokes a JSON parser to convert the response string into an internal object.

The terminal extracts the value associated with the “proposal” key and stores it as a display_text variable.
Input: JSON-formatted response string from the server.
Output: display_text string on the terminal containing the generated natural language expression.

### Step 12:

The terminal outputs the generated natural language expression to the user via the display device.

The terminal updates a designated area of the user interface and renders the display_text using its graphical toolkit, such that the suggested communication method is shown as readable text.

The user views the displayed suggestion, and the terminal maintains the text in memory so that the user can scroll, copy, or initiate further actions based on the suggestion.
Input: display_text string stored on the terminal.
Output: visible presentation of the generated communication method on the terminal's display device.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented communication support systems typically transform user-authored text by applying static rule-based filters, template substitution, or simple sentiment analysis. Such systems do not adequately capture the nuanced intent of a user or dynamically adapt to the emotional state of a counterpart in real time. As a result, these systems often produce responses that are grammatically correct but contextually inappropriate, overly generic, or misaligned with the relationship between the user and the counterpart, thereby reducing the effectiveness of the system in practical face-to-face service scenarios.

Further, existing architectures usually treat natural language input processing, emotional state estimation, and response generation as separate, loosely coupled functions. They do not integrate multimodal data, such as facial expression information, with user-provided intent and relationship information in a unified computational pipeline. This leads to underutilization of available contextual signals and prevents the system from generating responses that are optimally tailored to the current interaction state.

Moreover, many known systems that invoke a generative AI model treat the model as a black box that simply receives the raw user input. These systems lack a systematic mechanism to construct structured, situation-aware prompt sentences that condition the generative AI model on the user's honest feelings, the degree of respect required, the relationship with the counterpart, and the counterpart's current emotional state inferred from image data. Consequently, the generated responses may not consistently satisfy application-specific constraints regarding politeness, level of deference, or actionability in a service workflow.

In addition, conventional solutions generally provide only a single-shot transformation of a user message, without temporal tracking of changes in the counterpart's emotional state. They do not continuously update the computational state of the system or adjust prompts and outputs as the interaction progresses. This static behavior limits the system's ability to support interactive, real-time dialogue in which the system must respond to changing expressions, tension levels, or satisfaction levels.

Therefore, there is a need for an improved computer-implemented communication support technique that (i) integrates natural language processing and image-based emotion recognition, (ii) generates structured, context-rich prompt sentences for a generative AI model, (iii) enforces programmable criteria for politeness and appropriateness when post-processing model outputs, and (iv) supports continuous, real-time updating of prompts and outputs according to temporal changes in facial expression data. Such a technique should improve the functioning of the computer system itself by providing a more effective and adaptive pipeline for generating user support responses in face-to-face communication environments.

The specific processing by the specific processing unit 290 of the data processing device 12 in Application Example 1 is realized by the following means.

The present invention provides a server comprising a processor configured to receive input information from a user, analyze the input information by using a natural language processing technique so as to evaluate an intention of the user and a degree of consideration for a counterpart, acquire image data from an image acquisition device and recognize a facial expression of a person included in the image data by using an image processing technique and a classification model so as to generate expression data indicating an emotional state of the person, integrate situation information including the intention of the user, a relationship with the counterpart, and the expression data, generate a prompt sentence for input to a generative artificial intelligence model on the basis of the situation information, transmit the prompt sentence to an external generative artificial intelligence model and receive a response sentence generated by the external generative artificial intelligence model, adjust content of the response sentence on the basis of evaluation criteria relating to consideration for the counterpart, politeness, and appropriateness of wording so as to generate an output sentence obtained by converting the intention of the user into an expression that respects the counterpart, and transmit the output sentence to a terminal device and cause the output sentence to be presented to the user through the terminal device. This enables an improved computer-implemented communication support operation in which the server constructs context-rich prompt sentences that jointly encode user intent, relationship information, and real-time facial expression data, systematically constrains and refines responses generated by the generative artificial intelligence model according to programmable criteria, and dynamically adapts output text to the evolving emotional state of the counterpart, thereby enhancing the technical performance and effectiveness of the overall communication support system.

The term “input information” refers to information provided by a user, including at least text data expressing the user's intention, an honest feeling of the user, and information indicating a relationship with a counterpart, and optionally including additional context information regarding a communication situation.

The term “user” refers to a human operator who interacts with the system and provides the input information, and who utilizes an output sentence generated by the system as support for communication with a counterpart.

The term “counterpart” refers to a person with whom the user communicates or intends to communicate, and whose emotional state and relationship with the user are taken into account by the system when generating an output sentence.

The term “terminal device” refers to an information processing apparatus, such as a handheld device, a portable computer, or a stationary display device, that is configured to transmit the input information to a server and to present an output sentence to the user.

The term “processor” refers to one or more information processing circuits, such as a central processing unit, a microcontroller, or a hardware accelerator, configured to execute instructions for performing functions of the system, including analysis of input information, generation of situation information, and control of communication with an external model.

The term “natural language processing technique” refers to a computer-implemented procedure for analyzing text expressed in a natural language, including at least parsing, tokenization, classification, or semantic analysis, in order to extract information such as an intention of a user and a degree of consideration for a counterpart.

The term “intention of the user” refers to a communicative goal or purpose that the user wishes to achieve through interaction with the counterpart, such as apologizing, refusing a request, proposing an alternative, or explaining information.

The term “degree of consideration for a counterpart” refers to an extent to which the user wishes to express respect, politeness, or deference toward the counterpart in a communication, and is evaluated by the processor on the basis of the input information.

The term “relationship with the counterpart” refers to a classification indicating a relational state between the user and the counterpart, such as a first-time customer, a repeat customer, a long-term client, or a privileged client, which influences selection of wording and a level of politeness in the output sentence.

The term “image acquisition device” refers to a hardware device that captures image data including at least a face of a person, such as a camera, an image sensor, or a video capturing apparatus.

The term “image data” refers to digital data representing images or video frames obtained from the image acquisition device and including at least a region in which a face of a person is depicted.

The term “image processing technique” refers to a computer-implemented procedure for processing image data, including at least face detection, region extraction, and preprocessing of image regions in order to support recognition of a facial expression.

The term “classification model” refers to a learned computational model, such as a statistical model or a machine learning model, trained to classify a facial expression or an emotional state of a person on the basis of image data representing a face.

The term “facial expression” refers to a configuration of facial features of a person that is observable in image data and is indicative of an emotional state, such as satisfaction, dissatisfaction, happiness, anger, confusion, or neutrality.

The term “expression data” refers to structured data generated by the processor that represents an estimated emotional state of a person, including at least a label of a facial expression and optionally a confidence value or probability associated with the label.

The term “situation information” refers to structured information integrated by the processor and including at least the intention of the user, the relationship with the counterpart, and the expression data, and optionally including temporal information, context information, or language preference, for use in generating a prompt sentence.

The term “generative artificial intelligence model” refers to an artificial intelligence model configured to generate natural language text in response to a given prompt sentence, the model being implemented on a computing system and accessible to the server through a communication interface.

The term “prompt sentence” refers to a natural language text generated by the processor and provided as input to the generative artificial intelligence model, the text describing at least the situation information including the intention of the user, the relationship with the counterpart, and the expression data.

The term “external generative artificial intelligence model” refers to a generative artificial intelligence model that is executed on a computing system separate from the processor of the server and that is accessed by the server via a communication network.

The term “response sentence” refers to natural language text generated by the external generative artificial intelligence model in response to the prompt sentence and received by the processor.

The term “evaluation criteria” refers to predefined rules, thresholds, or models used by the processor to assess consideration for the counterpart, politeness, and appropriateness of wording contained in the response sentence.

The term “output sentence” refers to text generated by the processor by adjusting the content of the response sentence on the basis of the evaluation criteria so that the text expresses the intention of the user in a manner that respects the counterpart.

The term “consideration for the counterpart” refers to a property of wording used in communication that reflects attention to the counterpart's feelings, position, and relationship with the user, and that aims to avoid causing discomfort or disrespect.

The term “politeness” refers to a level of formality, deference, and courtesy in wording, evaluated and controlled by the processor when generating or adjusting the response sentence and the output sentence.

The term “appropriateness of wording” refers to suitability of a phrase or sentence for a given communication context, including correctness, clarity, and compliance with constraints of a service scenario, as determined by the processor.

The term “presented to the user through the terminal device” refers to an operation in which the output sentence is displayed, output as audio, or otherwise rendered on an interface of the terminal device so that the user can perceive and utilize the output sentence in communication.

The server implements the invention by executing a communication support program on one or more processors connected to a memory, a communication interface, and an image acquisition device. The terminal implements a user interface program on a processing unit of a client apparatus.

The user operates the terminal in a face-to-face service environment, such as a counter, a reception desk, or a consultation booth, where a counterpart is physically present in front of a camera connected to the server.

The server uses general-purpose hardware such as a central processing unit, a graphics processing unit, and a system memory implemented by a semiconductor storage device. The server executes software modules implemented, for example, in a general-purpose programming language running on an operating system. The server uses a web framework to provide an application programming interface over a communication network and uses a database management system to store input information, situation information, and output sentences. The server uses an image processing library such as a generic open-source computer vision library and uses a machine-learning framework such as a generic deep learning framework to implement a facial expression recognition model and auxiliary classifiers. The server further uses a client library to communicate with an external generative AI model hosted on a remote computing system.

The terminal uses client hardware such as a handheld information processing device or a personal computer equipped with a display, an input interface, and a wireless or wired communication interface. The terminal executes an application that presents input fields, buttons, and other graphical elements to the user and transmits structured input information to the server. The terminal receives an output sentence and renders the output sentence as text or synthesized audio so that the user can immediately employ the wording in communication with the counterpart.

The user inputs to the terminal at least a free-form text describing the user's honest feelings, the target action (for example, apology, refusal, explanation, or proposal), and additional context, such as whether the counterpart is a repeat customer or a first-time visitor. The user also selects a relationship category for the counterpart from a prepared list stored in the terminal memory. The terminal converts the input into an internal data structure such as an object containing fields representing the intention of the user, the honest feeling of the user, the relationship with the counterpart, and optional metadata. The terminal transmits this data structure to the server via a network using a standardized communication protocol.

The server receives the input information and stores it in a structured format in a database table. The server then uses a natural language processing module to analyze the input text. The natural language processing module includes at least a tokenizer, a part-of-speech tagger, a dependency parser, and a semantic classifier. The server applies these components to the input text to extract features such as grammatical structure, sentiment polarity, intensity of emotion, and intent category.

The server maps the extracted features to a numerical feature vector stored in memory, where each dimension corresponds to, for example, an intent score, a politeness requirement score, an urgency score, and an emotional intensity score.

The server evaluates the degree of consideration for the counterpart based on the feature vector and a rule set stored in memory. The rule set specifies, for example, that when the relationship category indicates a long-term client, a higher threshold is applied for politeness and deference, and when the user's honest feeling indicates strong frustration, an additional adjustment is applied to prevent direct expression of negative emotions. The server computes a “consideration index” as a weighted combination of these features by multiplying the feature vector by a pre-stored weight vector and normalizing the result. This yields a numerical value indicating how much respect and care the wording should embody.

The server simultaneously acquires image data from the image acquisition device attached to the server or to a network-connected apparatus. The image acquisition device captures a sequence of frames in real time. The server uses an image processing library to perform face detection on each frame. The server identifies face regions by applying a trained detector such as a convolutional neural network-based detector or a cascade classifier. The server normalizes the face regions by resizing, converting color spaces, and performing intensity normalization. The server then feeds the normalized face images into a facial expression recognition model implemented as a convolutional neural network.

The facial expression recognition model in one embodiment is configured with several convolutional layers followed by pooling layers, normalization layers, and fully connected layers. The input layer receives a fixed-size grayscale or color image patch. Each convolutional layer applies a set of learnable filters to compute feature maps representing local patterns such as edges, eyes, and mouth shapes. The pooling layers perform subsampling to reduce spatial resolution while retaining salient structures, thereby reducing computational cost and improving robustness to small shifts. The fully connected layers map the flattened feature maps to a set of output neurons, each corresponding to an emotion class such as happiness, anger, sadness, confusion, satisfaction, or dissatisfaction. The server applies a softmax function to the outputs to obtain a probability distribution over emotion classes.

The server trains this model offline on an annotated dataset comprising face images labeled with emotion classes. During training, the server uses a loss function such as cross-entropy loss between the predicted probabilities and the true labels. The server updates the weights of the network using a gradient-based optimization algorithm, such as stochastic gradient descent with momentum or an adaptive learning rate optimizer. The server may apply data augmentation techniques such as random cropping, rotation, and brightness adjustment to increase robustness and reduce overfitting. After training, the server stores the optimized weights in a model file in non-volatile storage and loads the model weights during runtime.

The server executes inference by passing each normalized face image through the trained model and receiving a probability vector. The server selects the emotion class with the highest probability as the facial expression label and records the probability as a confidence score. The server maintains a temporal buffer of recent expression labels and confidence scores and computes a moving average or a majority vote to obtain a stable expression estimate that is less sensitive to noise and momentary facial fluctuations. The server stores the stable expression label and the aggregated confidence score as expression data in an internal data structure.

The server integrates the intention information, relationship information, and expression data into situation information. The situation information is implemented as a structured record containing fields for the intent category, the consideration index, the relationship category, the stable expression label, the aggregated confidence, and optional temporal indicators such as time since the start of the interaction. The server computes an interaction state code by combining these fields using a mapping function. The interaction state code, for example, discretely identifies situations such as “dissatisfied long-term client in apology scene” or “confused first-time visitor in explanation scene.”

The server generates a prompt sentence for a generative AI model based on the situation information. The server stores in memory multiple prompt templates, each associated with a type of interaction state. Each template contains placeholders for at least the facial expression descriptor, the relationship descriptor, and the description of the user's intention and goal. The server selects an appropriate template based on the interaction state code and fills the placeholders with text derived from the situation information. As a result, the server constructs a prompt sentence that accurately describes the current communication context.

The server can generate prompt sentences such as:
“The customer's facial expression is dissatisfied, and the relationship is a regular customer. The staff member's true intention is to refuse the customer's request without damaging the relationship. Please propose a polite and respectful response in English that clearly and gently refuses the request while maintaining goodwill.”
“The customer's facial expression is confused, and the relationship is a first-time visitor. The staff member's goal is to explain a complicated subscription plan clearly and gently, without sounding pushy. Please create a polite, easy-to-understand explanation in English suitable for a first-time customer.”
“The customer's facial expression is happy, and the relationship is a VIP customer. The staff member wants to propose a premium optional service as an upsell while showing appreciation. Please suggest a natural and respectful English sales talk that leverages the positive mood and emphasizes the VIP status.”

The server sends the prompt sentence to an external generative AI model through a communication interface. The external generative AI model in one embodiment is implemented as a neural sequence model such as a transformer architecture running on a remote server. The model uses multiple layers of self-attention mechanisms to process the prompt sentence and to output a response sentence token by token. The model has been trained on a large corpus of text data to learn syntactic and semantic patterns and has been fine-tuned on domain-specific communication tasks if required. The server accesses the model via an application programming interface exposed over a network.

The server receives the response sentence from the external generative AI model and stores it in memory. The server then executes a post-processing module that evaluates the response sentence based on evaluation criteria stored in rule sets and machine-learned classifiers. The evaluation criteria include, for example, maximum allowed length, minimum politeness level, prohibited phrases, and alignment with the user's intention category. The server parses the response sentence with a natural language processing component, computing features such as presence of imperative phrases, sentiment polarity, modality markers, and honorific expressions. The server uses a classifier trained to assign a politeness score and a risk score to the response sentence.

The server compares these scores with thresholds defined in a configuration file. If a score is outside an acceptable range, the server modifies the sentence by applying a transformation pipeline. The transformation pipeline can include operations such as replacing direct expressions with softer phrases, inserting appreciation phrases at the beginning or end of the message, simplifying complex clauses, or removing speculative or ambiguous parts. The server uses a combination of rule-based rewriting and lightweight sequence-to-sequence models deployed locally to perform these adjustments. The adjusted sentence becomes the output sentence that expresses the user's intention in a manner that satisfies the consideration index and the politeness requirement associated with the relationship and expression data.

The server transmits the output sentence to the terminal. The terminal displays the output sentence on a screen in a user interface region reserved for system suggestions. The terminal may also render a phonetic guide or trigger a text-to-speech engine to produce an audio output, enabling the user to quickly grasp the suggested wording even while directly engaging with the counterpart. The user reads or listens to the output sentence and, based on the wording, conducts the face-to-face interaction more smoothly.

The server in some embodiments continuously acquires new image data and updates the expression data as the interaction progresses. When the server detects that the facial expression has transitioned, for example, from dissatisfaction to neutrality or from confusion to understanding, the server updates the situation information and regenerates a new prompt sentence and output sentence. This continuous updating makes the support adaptive and allows the computer system to respond to dynamic changes in emotional state, which is difficult to achieve with static human-written scripts.

The system architecture improves computer technology in several respects. The server performs multimodal fusion of text-based intention features and image-based emotion features in a compact situation information structure and uses an interaction state code to select and construct prompt sentences efficiently. This reduces the amount of data sent to the external generative AI model, thereby reducing communication load and latency. The server also performs local post-processing and conformity checking to prevent repeated calls to the external model for minor adjustments, which improves processing speed and resource utilization.

The server uses specialized neural network architectures and training procedures for facial expression recognition, leading to higher recognition accuracy compared to simple rule-based emotion estimation. Because the server aggregates expression data over time and uses confidence-weighted smoothing, the system reduces misclassification noise and increases stability of emotion estimates, which directly contributes to more appropriate prompt generation and output sentence generation. The integration of temporal buffering and fusion of multimodal features is not a mere automation of a human mental process; instead, it is a specific computational technique that reorganizes data structures and processing order to enhance precision and responsiveness of the system.

The server's use of prompt templates indexed by interaction state codes and the computation of a consideration index represent a non-conventional procedure distinct from usual human drafting. Human operators often rely on ad hoc judgment, whereas the server quantifies politeness and emotional requirements numerically and then enforces these constraints algorithmically when constructing prompt sentences and adjusting response sentences. This numerical and template-driven approach enables consistent and reproducible control of tone and content, and it allows calibration and optimization through machine-learning techniques.

The server can, in alternative embodiments, employ different model architectures. For example, the facial expression recognition model can be realized as a residual network, a depthwise separable convolution network, or a combination of convolutional and recurrent layers to capture short temporal patterns across several frames. The generative AI model can be a decoder-only transformer or an encoder-decoder model. The server can cache intermediate embeddings obtained from the generative AI model for partial reuse when only small changes occur in the situation information, thereby reducing computation required at the external model and accelerating response time.

The terminal, in alternative embodiments, can be implemented as a head-mounted display or an augmented-reality device. In such configurations, the terminal overlays the output sentence or key phrases in the user's field of view, permitting the user to maintain eye contact with the counterpart while receiving support. This constitutes a specific technical use of the generated output sentence, in which the computer system controls a display device in coordination with real-time camera capture, leading to an integrated man-machine interface not achievable with paper-based manuals.

The server, in further embodiments, can locally store anonymized logs of situation information and corresponding output sentences. The server can periodically retrain or fine-tune internal classifiers and rewriting rules based on successful interactions flagged by the user or by downstream metrics.

The training process uses an error function that measures divergence between desired politeness level and the level inferred from the generated text, and updates internal weights via gradient descent. Over time, this adaptive learning improves the precision of intent inference, the reliability of emotion recognition, and the quality of prompt construction, thereby enhancing the technical performance of the system without manual rule tuning.

The system thus provides a concrete technical solution that extends beyond mere automation of human judgment. The server employs specific data structures, machine-learned models, and multimodal fusion algorithms to produce context-aware, adaptive prompt sentences and output sentences. These computational techniques reduce miscommunication, shorten response generation time, lower network load to external models, and increase accuracy and stability of emotion estimation. The terminal and the image acquisition device cooperate with the server in a coordinated fashion, resulting in an integrated communication support apparatus that improves the operation of computer systems in the real-time, face-to-face service environment.

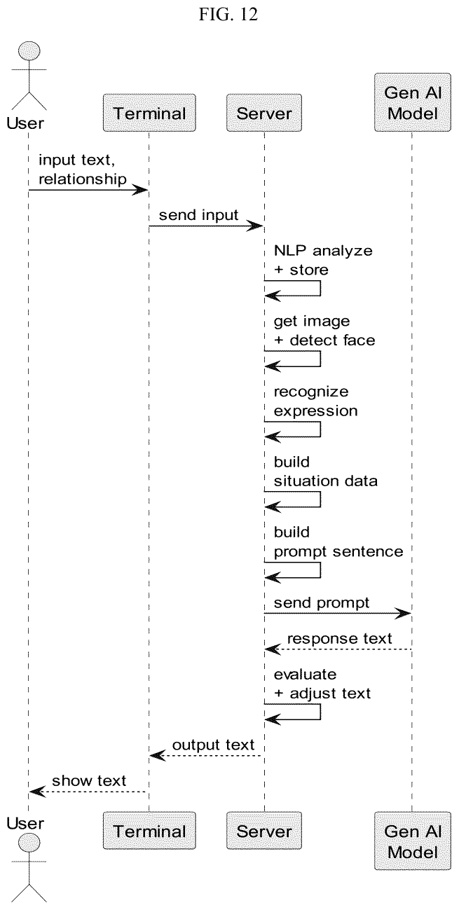

The following describes the processing flow using FIG. 12.

### Step 1:

The terminal displays an input screen to the user and acquires initial interaction data.

The user inputs free-form text describing an honest feeling, a desired action (such as apology or refusal), and contextual information, and selects a relationship category for the counterpart from options shown on the display.

The terminal receives, as input, keystrokes and selection events from the user interface and converts them into structured input information containing at least a text string, a relationship label, and optional metadata such as language and service type.

The terminal performs basic validation on the text length and checks that a relationship label is selected, then outputs a structured data object representing the input information.

### Step 2:

The terminal transmits the structured input information to the server.

The terminal receives, as input, the structured data object created in Step 1, serializes the object into a message format, and sends it via a communication interface to a predefined server endpoint.

The terminal uses a network protocol to encapsulate the message and attaches session identifiers and authentication data.

The terminal outputs a network request containing the serialized input information and awaits a response acknowledgment from the server.

### Step 3:

The server receives and persists the input information.

The server takes, as input, the network request from the terminal, decodes the message, and parses the serialized data into an internal representation.

The server validates required fields, checks data types, and normalizes the relationship label into a standard internal code.

The server stores the normalized input information in a database record associated with a session identifier and outputs a structured record that can be accessed by further processing modules.

### Step 4:

The server performs natural language analysis on the user's text.

The server receives, as input, the text string from the stored record and processes it with a natural language processing pipeline that includes tokenization, part-of-speech tagging, dependency parsing, and semantic classification.

The server computes numerical features such as intent scores, sentiment polarity, emotional intensity, and politeness requirement, by applying trained classifiers and rule-based mappings to the parsed text.

The server outputs a feature vector and an inferred intent label representing the intention of the user.

### Step 5:

The server calculates a consideration index for the counterpart.

The server receives, as input, the feature vector from Step 4 and the normalized relationship code from the stored record.

The server applies a weighted combination of the features and the relationship code by multiplying them with pre-defined weight parameters and summing the results, thereby computing a numerical score representing a degree of consideration required for the counterpart.

The server outputs a consideration index that will later constrain the tone and politeness level of generated wording.

### Step 6:

The server acquires image data and detects a face in the image.

The server receives, as input, raw image frames from an image acquisition device at a predetermined frame rate.

The server applies a face detection algorithm to each frame using an image processing library and a pre-trained face detector to locate one or more face regions.

The server crops the detected face region, resizes it to a fixed dimension, converts color space if necessary, and outputs a normalized face image suitable for expression recognition, together with detection confidence.

### Step 7:

The server recognizes a facial expression and generates expression data.

The server receives, as input, the normalized face image from Step 6 and forwards it through a trained neural network for facial expression recognition.

The server computes, in the network, convolutional activations, pooling operations, and fully connected layer outputs, and applies a softmax function to obtain a probability distribution over emotion classes.

The server selects the class with the highest probability as the facial expression label and combines it with the probability value to form expression data.

The server outputs expression data including at least the expression label and a confidence score.

### Step 8:

The server stabilizes expression data over time.

The server receives, as input, a sequence of expression data items produced in Step 7 for recent frames and maintains them in a temporal buffer.

The server applies a smoothing algorithm such as a moving average of probabilities or a majority vote over labels to reduce short-term fluctuations and noise.

The server outputs a stable expression estimate that includes a consolidated label and an aggregated confidence value.

### Step 9:

The server integrates situation information.

The server receives, as input, the inferred intent label and feature vector from Step 4, the consideration index from Step 5, the relationship code from Step 3, and the stable expression estimate from Step 8.

The server composes these elements into a structured situation record that includes fields for intent category, consideration index, relationship category, expression label, expression confidence, and optional temporal metadata.

The server derives an interaction state code by mapping key combinations of these fields to a discrete state identifier.

The server outputs both the situation record and the interaction state code.

### Step 10:

The server generates a prompt sentence for a generative AI model.

The server receives, as input, the situation record and the interaction state code from Step 9. The server selects a prompt template associated with the interaction state code from a template store and fills template placeholders with corresponding text fragments generated from the intent category, relationship category, and expression label.

The server formulates a coherent natural language text that includes a description of the customer's expression, the relationship, and the user's true intention, and outputs this text as a prompt sentence.

### Step 11:

The server transmits the prompt sentence to an external generative AI model and obtains a response.

The server receives, as input, the prompt sentence from Step 10 and encapsulates it into a request message formatted according to an external model's application programming interface.

The server sends the request through a communication interface to a remote computing system hosting the generative AI model and waits for a response.

The server receives a response message containing a response sentence generated by the generative AI model, extracts the text content, and outputs the response sentence.

### Step 12:

The server evaluates the response sentence against evaluation criteria.

The server receives, as input, the response sentence from Step 11 and the consideration index and relationship category from the situation record in Step 9.

The server parses the response sentence with a natural language module to identify sentence structure, sentiment, modality, and politeness markers, and computes scores such as politeness level, risk level, and content alignment with the user's intent.

The server compares these scores with thresholds derived from the consideration index and the relationship category, and outputs a set of evaluation results indicating whether modifications are necessary and which aspects require adjustment.

### Step 13:

The server adjusts the response sentence to form an output sentence.

The server receives, as input, the response sentence and the evaluation results from Step 12.

The server applies a transformation pipeline consisting of rule-based rewriting and, when necessary, lightweight text generation modules, to replace direct expressions with softer formulations, insert appreciation phrases, or remove inappropriate segments.

The server iteratively refines the text until the computed scores satisfy the thresholds associated with the consideration index.

The server outputs the final adjusted text as an output sentence that expresses the user's intention in a manner that respects the counterpart.

### Step 14:

The server sends the output sentence to the terminal.

The server receives, as input, the output sentence from Step 13 and a session identifier associated with the user.

The server packages the output sentence into a response message with metadata such as tone indicators and task type and transmits the message over the network to the terminal identified by the session.

The server outputs a network response containing the output sentence and logs the transmission for later analysis.

### Step 15:

The terminal presents the output sentence to the user.

The terminal receives, as input, the network response from the server and extracts the output sentence and associated metadata.

The terminal renders the output sentence in a designated area of the user interface and optionally invokes a text-to-speech component to generate an audio signal.

The terminal outputs the visual and/or audio representation of the suggested wording so that the user can immediately perceive and utilize the output sentence.

### Step 16:

The user reviews and optionally acts on the output sentence.

The user receives, as input, the displayed or spoken output sentence from the terminal and interprets the suggested wording.

The user may decide to repeat the output sentence verbatim, adapt it slightly before speaking, or use it as a reference to shape a spontaneous utterance in the ongoing face-to-face conversation.

The user outputs, in the physical environment, a spoken response to the counterpart that is informed by the output sentence generated by the system.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented communication support systems typically focus on shallow text-level operations, such as keyword filtering, template-based rewriting, or sentiment polarity detection. Such systems often fail to accurately capture the underlying intent of a user or the nuanced degree of respect expressed toward a counterpart in natural language messages. As a result, the systems cannot reliably guide users to adjust their expressions to align with social norms, organizational policies, or interpersonal expectations, especially in contexts requiring high levels of courtesy, such as business communication or hierarchical relationships.

Furthermore, existing systems that attempt to incorporate machine learning models or generative models often treat those models as independent black boxes, without tightly integrating deterministic natural language processing pipelines with generative inference. This loose coupling can lead to unstable or inconsistent evaluation of respect levels, lack of transparency regarding why a given expression is considered polite or impolite, and difficulty in systematically improving user communication behavior based on feedback from the system.

In addition, conventional systems typically do not provide a structured mechanism for combining rule-based or statistical natural language analysis (such as tokenization, part-of-speech tagging, and dependency parsing) with generative model outputs in a way that produces both interpretable analytic results and concrete, higher-courtesy alternative expressions. Without such a mechanism, it is difficult for a computer system to provide users with both (i) a clear explanation of how their original messages will likely be perceived in terms of respect and (ii) actionable suggestions for revising those messages.

Accordingly, there is a need for a computer-implemented technique that improves the functioning of server-side communication analysis by: (i) accurately analyzing user intent and respect level through structured natural language processing, (ii) generating precise prompt sentences for a generative model based on that structured analysis, (iii) integrating the generative model's response with the deterministic analysis to produce stable and interpretable evaluation results, and (iv) providing the user, via a terminal, with both analytic feedback and multiple respectful alternative expressions. By addressing these issues, the invention aims to improve the technical performance of communication support systems, including consistency of analysis, controllability of generative output, and usability of the feedback loop between the user and the system.

The specific processing by the specific processing unit 290 of the data processing device 12 in Example 2 is realized by the following means.

The present invention provides a server comprising a processor configured to receive, via a communication network and a terminal, input information including character information from a user; analyze, by using a natural language processing technique executed on the processor, the input information to perform segmentation into lexical units, assignment of grammatical categories, and analysis of syntactic structure, thereby specifying a semantic structure of the input information and an intent of the user; determine, on the basis of the semantic structure and the intent of the user, presence and degree of courtesy expressions including honorific expressions, polite expressions, and indirect request expressions, and evaluate a degree of respect for a counterpart as a numerical value or a category; generate, on the basis of an evaluation result of the degree of respect and a result of specifying the intent of the user, a prompt sentence that instructs a generative information processing model to perform at least one of: conversion of the input information into an expression that respects the counterpart while maintaining the intent of the user, generation of an explanation of the degree of respect for the counterpart, and generation of an alternative expression having a higher level of courtesy; transmit the prompt sentence to the generative information processing model and acquire, from the generative information processing model, response information including at least one of: a summary of the intent regarding the input information, an evaluation result of the degree of respect for the counterpart, and conversion information obtained by converting the input information into the expression that respects the counterpart; integrate an evaluation result obtained by the natural language processing technique and the response information acquired from the generative information processing model to generate result information including at least the intent of the user, the degree of respect for the counterpart, and the expression that respects the counterpart; and transmit the result information to the terminal so that the terminal presents, to the user, at least a summary of the intent, the degree of respect for the counterpart, and the expression that respects the counterpart. This enables an improvement in computer-based communication processing by providing a technically structured pipeline that combines deterministic linguistic analysis with controlled generative inference, thereby producing consistent, interpretable, and actionable feedback on respect levels and alternative courteous expressions for user messages.

The term “processor” refers to a hardware computation unit, such as a central processing unit or an execution core, that executes instructions of one or more programs to implement the functions of the system.

The term “terminal” refers to an information processing device, such as a user's client device, that provides an input and output interface for a user and communicates with the server via a communication network.

The term “communication network” refers to an information transmission infrastructure, such as a wired network or a wireless network, that enables data exchange between the server and the terminal.

The term “input information” refers to data provided by a user to the system, including at least text data composed of character information that expresses the user's intended message.

The term “character information” refers to symbolic data elements, such as letters, numerals, punctuation marks, and other text symbols, that are arranged to form the user's natural language message.

The term “natural language processing technique” refers to a computerized processing procedure that analyzes human language, including at least segmentation into lexical units, assignment of grammatical categories, and analysis of syntactic structure.

The term “segmentation into lexical units” refers to a processing operation that divides a character string into smaller units, such as words, morphemes, or tokens, suitable for subsequent linguistic analysis.

The term “assignment of grammatical categories” refers to a processing operation that associates each lexical unit with a grammatical label, such as part of speech, indicating its syntactic or morphological role.

The term “analysis of syntactic structure” refers to a processing operation that determines structural relations among lexical units, such as dependency relations or phrase structures, to represent the syntactic organization of a sentence.

The term “semantic structure” refers to an internal representation of the meaning of the input information, derived from linguistic analysis, indicating relationships among concepts, roles, and predicates expressed in the text.

The term “intent of the user” refers to a communicative purpose or action that the user aims to achieve through the input information, such as making a request, issuing a command, asking a question, or expressing an opinion.

The term “courtesy expressions” refers to linguistic forms that indicate politeness or deference in communication, including but not limited to honorific expressions, polite expressions, and indirect request expressions.

The term “honorific expressions” refers to linguistic forms that explicitly show respect or deference toward a counterpart, such as honorific verbs, respectful titles, or respectful grammatical constructions.

The term “polite expressions” refers to linguistic forms that soften or formalize a statement to avoid rudeness, including polite sentence endings, polite auxiliary forms, and mitigating phrases.

The term “indirect request expressions” refers to linguistic forms that express a request in a non-imperative manner, such as interrogative or conditional forms that indirectly ask the counterpart to perform an action.

The term “degree of respect” refers to a quantified or categorized measure of how respectfully the user's input information addresses the counterpart, as determined by analyzing courtesy expressions and related linguistic features.

The term “counterpart” refers to a communication target person or entity presumed to receive or be addressed by the user's message.

The term “evaluation result” refers to data indicating an outcome of an analysis performed by the system, including at least a quantified or categorized degree of respect and, optionally, explanatory information.

The term “generative information processing model” refers to a computational model, such as a generative artificial intelligence model, that generates text or other data outputs in response to input conditions, including prompt sentences.

The term “prompt sentence” refers to an input instruction text supplied to the generative information processing model, specifying one or more tasks such as analysis, conversion, explanation, or generation of alternative expressions.

The term “conversion information” refers to data representing a transformed version of the input information, in which the user's intent is maintained while the expression is modified to show respect toward the counterpart.

The term “response information” refers to data returned from the generative information processing model, including at least one of an intent summary, an evaluation result of the degree of respect, and conversion information.

The term “result information” refers to data generated by integrating outputs of the natural language processing technique and the generative information processing model, including at least the intent of the user, the degree of respect, and an expression that respects the counterpart.

The term “summary of the intent” refers to a concise textual representation that describes, in a reduced form, the main communicative purpose contained in the user's input information.

The term “expression that respects the counterpart” refers to a textual expression derived from the input information or generated by the system, in which linguistic forms are selected to convey politeness and respect toward the counterpart.

The term “candidate expressions” refers to a plurality of alternative textual forms generated by the generative information processing model, each of which is intended to represent the user's message in a respectful manner.

The term “operation processing apparatus” refers to a computing apparatus used to manage tasks, workflows, or communications within an organization, including server devices that execute management or coordination programs.

The term “communication processing apparatus” refers to a computing apparatus that performs transmission, reception, or mediation of messages or data within an organization or between external parties.

The term “dialogue management” refers to control and support of interactive exchanges between users or between a user and a system, including guidance, evaluation, and adjustment of message content and style.

The term “electronic communication service” refers to a service that enables exchange of electronic messages, such as electronic mail, messaging platforms, or chat-based systems, via a communication network.

In one embodiment, the server implements the claimed system as a network-accessible communication assistance platform. The server includes at least one processor, a memory, a non-transitory storage medium, and a network interface. The server executes an operating system such as a server-class operating system, and application software implemented, for example, in a programming language runtime environment. The server stores and executes a natural language processing library, such as a library that provides tokenization, part-of-speech tagging, and dependency parsing, and also stores and executes a generative AI model implemented, for example, as a transformer-based neural network.

The terminal operates as a client device that interacts with the server. The terminal may be a smartphone, a tablet, a notebook computer, or a desktop computer. The terminal includes an input unit, such as a touch screen or keyboard, and a display unit, such as a liquid crystal display or an organic light-emitting diode display. The terminal executes a client application, such as a web browser or native application, that communicates with the server via a communication network, for example through Hypertext Transfer Protocol Secure (HTTPS).

The user operates the terminal to input text representing the user's intended message to a counterpart. The terminal sends this text, along with associated metadata such as language code and timestamp, to the server in a structured data format. The server receives this data via the network interface and stores it in a data structure in memory, such as a record with fields including an identifier, the raw text string, detected or declared language, and a processing status flag.

The server uses a natural language processing software component to analyze the received text. The server loads into memory a language model that supports tokenization, part-of-speech tagging, and dependency parsing for the relevant language. The server performs tokenization by converting the raw text string into an ordered list of tokens, each represented as a data structure containing at least a character span, a normalized form, and a token identifier. The server applies part-of-speech tagging to assign, to each token, a grammatical category label. The server then applies dependency parsing to construct a dependency graph, in which each token is represented as a node and grammatical relations between tokens are represented as directed edges. The server stores this dependency graph in memory as a graph data structure or as a set of relations referencing token identifiers.

The server derives a semantic structure from the dependency graph. For example, the server identifies predicate-argument structures by locating verb tokens and associating subject, object, and complement tokens according to dependency relations. The server maps these structures to an internal representation of user intent, such as an intent label (“schedule_change_request”, “information_request”, “apology”, and so on) and associated slots (for example, “target=meeting”, “attribute=time”). In one embodiment, the server uses a rule-based classifier that evaluates patterns over part-of-speech tags and dependency relations to assign an intent label. In another embodiment, the server uses a trained classifier, such as a multilayer neural network that takes as input a sequence of token embeddings and dependency features and outputs an intent category.

The server evaluates the degree of respect in the user's message by detecting courtesy expressions. The server maintains, in a persistent storage medium, a lexicon of lexical and syntactic patterns associated with honorific expressions, polite expressions, and indirect request expressions. For example, in a certain language, the lexicon may include patterns such as an auxiliary verb form that expresses politeness or a sentence-final particle that indicates respect. The server compares the analyzed tokens and dependency relations against these patterns. For each match, the server updates a feature vector that includes counts or binary flags for different categories of courtesy markers, such as “honorific_verb_present”, “polite_auxiliary_present”, “indirect_question_form_present”, and “mitigation_phrase_present”.

The server calculates a numerical respect score using an evaluation function that maps the feature vector to a scalar value. In one example, the server uses a weighted sum of features, where each feature is multiplied by a parameter weight and the sum is normalized to a fixed range. The weights can be determined empirically or by training on annotated corpora in which human experts have labeled respect levels for example sentences. The server also assigns a categorical label to the degree of respect, such as “low”, “medium”, or “high”, based on threshold values applied to the numerical score. The server stores the score, the label, and the underlying features in a structured record, allowing the system to later explain which specific markers contributed to the evaluation.

The server generates a prompt sentence for a generative AI model based on the user intent and respect evaluation. The server constructs the prompt sentence by combining template text with dynamic fields that contain the user's original message, the recognized intent label, and the current respect score. The server uses a deterministic template engine to ensure that the prompt sentence adheres to a consistent format, thereby improving the stability and controllability of the generative AI output. For example, the server may generate a prompt sentence such as:
“Analyze the following user message and determine both the user's intent and the degree of respect expressed toward the recipient. Message: ‘Could you please change the meeting time?’. First, summarize the user's intent in one sentence. Second, rate the respect level on a scale from 1 (very low) to 5 (very high) and explain your reasoning briefly.”

In another example, the server may generate a prompt sentence of the following form:
“Given the user's message: ‘Change the meeting time.’, evaluate how respectful this expression is in a business context (1=very low, 5=very high). Then rewrite this message as a more respectful and polite request suitable for an email to a colleague or manager.”

The server sends the prompt sentence to a generative AI model. In one embodiment, the generative AI model is implemented as a transformer-based deep neural network that has been pre-trained on large corpora of text and fine-tuned on conversational or instruction-following tasks. The model contains multiple self-attention layers, feed-forward layers, and normalization layers, and uses token embeddings and positional encodings to represent input text. The server encodes the prompt sentence into tokens using a tokenizer associated with the model and then sends the token sequence to the generative AI model via an application programming interface. The server specifies parameters such as maximum output length, generation temperature, and sampling strategy (for example, top-k sampling or nucleus sampling).

The generative AI model processes the tokenized prompt sentence by computing hidden representations at each layer, using learned weight matrices and nonlinear activation functions. The model predicts the next token probabilities at each step according to a softmax function applied to the output of the final layer. The model generates an output sequence of tokens, which the server decodes back into a text response. The server receives this response and parses it according to a predetermined format. For example, the response may contain a section indicating an intent summary, a section indicating a respect rating, and a section containing one or more revised polite expressions.

The server integrates the output of the generative AI model with the deterministic natural language processing results. The server compares the respect score suggested by the generative AI model with the score computed from the feature vector. If both scores are within a predetermined tolerance range, the server may adopt the generative model's textual explanation while retaining the deterministic score. If the scores diverge significantly, the server may apply an arbitration rule that either favors the deterministic evaluation or triggers re-analysis using alternative thresholds. By combining rule-based or feature-based evaluation with generative explanations, the server produces results that are both quantitatively consistent and qualitatively interpretable.

The server generates result information containing at least the original user message, a summary of the user's intent, the numerical and categorical respect evaluation, an explanation that identifies which linguistic markers were detected, and one or more alternative expressions that respect the counterpart. The server formats this result information into a structured response and transmits it to the terminal.

The terminal receives the structured response and displays the relevant information to the user. The terminal may show the intent summary as a concise sentence, present the respect level with a numeric score and a qualitative label, and list alternative polite expressions in selectable form. The user can tap or click a displayed alternative expression to adopt it, modify it further, or discard it.

The terminal may then use the adopted expression in an external communication application such as an email client or a messaging application.

This architecture improves computer technology in several ways. First, the server uses explicit feature extraction and graph-based syntactic analysis to compute a respect score using a deterministic algorithm. This structured representation reduces ambiguity, improves reproducibility, and allows pre-computation and caching of intermediate features, which decreases processing time for repeated or similar messages. Second, the server confines the generative AI model to a controlled role by supplying well-structured prompt sentences and parsing the model's output into well-defined fields. This reduces the risk of inconsistent or off-topic outputs and allows the server to validate generative results against deterministic analyses, thereby improving overall accuracy and stability of the system.

Moreover, the server uses specialized data structures to manage analysis results, such as feature vectors for courtesy markers, dependency graphs for syntactic structure, and intent-slot records for semantic roles. These structures enable efficient querying and statistical aggregation across large volumes of messages, allowing the system to optimize parameters and update thresholds based on observed distributions. The combination of deterministic and generative components also enables selective offloading of specific subtasks to the generative AI model, thereby reducing communication load and computational cost by avoiding unnecessary generation when the deterministic evaluation is sufficient.

In another embodiment, the server fine-tunes the generative AI model using training data that includes pairs of original messages and human-authored polite rewrites, together with annotated respect levels. The server uses a supervised learning process with a loss function that combines a language modeling objective and a respect-level classification objective. The server updates the model weights through gradient-based optimization, such as stochastic gradient descent with adaptive learning rate. By training the model specifically for respect-aware rewriting, the server enhances the model's ability to generate polite alternatives that align with the deterministic respect evaluation, thereby further improving technical performance.

In a further embodiment, the server maintains multiple natural language processing pipelines for different languages or domains and dynamically selects an appropriate pipeline based on language detection or user profile information. The server may also maintain multiple generative AI models with different capacities or specialization levels and select one based on the complexity of the input and available computing resources. This multi-pipeline and multi-model configuration allows the server to optimize processing speed, accuracy, and resource usage, which constitutes a technical improvement over systems that rely on a single undifferentiated model.

In yet another embodiment, the server compresses and indexes intermediate analysis results in a database, for example storing token sequences, feature vectors, and respect scores using compact representations. This enables the server to quickly retrieve previous analyses when a similar message is processed, and to reuse partial results, thereby reducing overall computation time and network bandwidth usage between the server and terminal.

The described system does not merely automate human judgment about politeness; instead, the server implements a specific combination of linguistic feature extraction, rule-based scoring, controlled prompt sentence generation, and structured integration of generative model outputs. This combination changes the way the computer processes and manages communication data, resulting in improved evaluation precision, faster processing, reduced inconsistency, and enhanced interpretability compared to conventional systems that rely solely on either rule-based methods or unconstrained generative models.

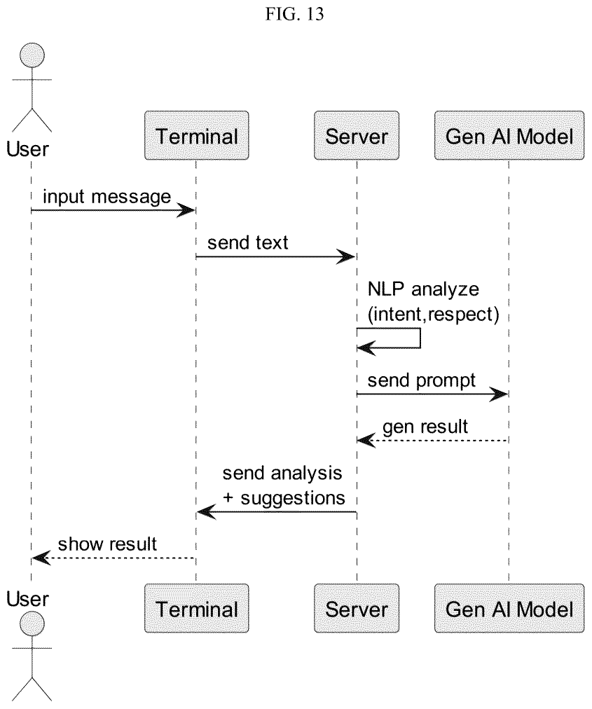

The following describes the processing flow using FIG. 13.

### Step 1:

The user operates the terminal to input a natural language message. The user types character information, such as “Change the meeting time.” or “Could you please change the meeting time?”, by using an input interface of the terminal. The terminal sets this message as input and generates a structured request object including at least a text field, a language code, a user identifier, and a timestamp. The terminal performs data formatting by encapsulating these fields into a data structure and outputs the structured request object to be transmitted to the server via a communication network.

### Step 2:

The terminal transmits the structured request object to the server. The terminal uses a communication protocol, such as HTTPS, to send the request to a predetermined endpoint of the server. The input for this step is the structured request object including the user's text and metadata. The terminal performs data serialization (for example, converting internal objects into a text-based representation) and network transmission, and outputs a network message that the server can receive and parse.

### Step 3:

The server receives the network message sent from the terminal and decodes it. The input for this step is the network message containing the structured request object. The server uses a network interface and a communication stack to parse the protocol headers, and a parsing component to convert the serialized data back into an internal data structure. The server performs validation of required fields, checks for supported language codes, and stores the request in memory, thereby outputting a verified request record that is ready for linguistic analysis.

### Step 4:

The server performs tokenization on the user's text. The input for this step is the raw text string extracted from the verified request record. The server uses a natural language processing library to split the text into a sequence of tokens, each represented by indices, character spans, and normalized forms. The server executes a tokenization algorithm that scans the character sequence, identifies word boundaries and punctuation, and constructs a token list. The server outputs a tokenized representation, which is a data structure containing an ordered list of token objects linked to the original text.

### Step 5:

The server assigns grammatical categories to the tokens. The input for this step is the tokenized representation generated in Step 4. The server uses a part-of-speech tagging model to compute, for each token, a probability distribution over possible tags and selects the most probable tag according to learned parameters. The server performs a sequence labeling computation using a trained statistical model or neural tagger, and attaches a grammatical category (such as noun, verb, adjective, or particle) to each token. The server outputs an annotated token sequence in which each token is associated with at least one part-of-speech tag.

### Step 6:

The server performs syntactic dependency parsing. The input for this step is the annotated token sequence from Step 5. The server uses a dependency parser that evaluates possible head-dependent relations among tokens based on features derived from the token sequence and their tags. The server computes scores for candidate arcs using a trained model, selects a set of arcs that form a valid dependency tree or graph, and assigns dependency labels (such as subject, object, modifier) to the arcs. The server outputs a dependency structure in the form of a graph data structure, where each node references a token and each edge represents a syntactic relation.

### Step 7:

The server infers the user's intent from the dependency structure. The input for this step is the dependency structure along with the underlying token and tag information. The server applies an intent classification algorithm that evaluates features such as main verb lemmas, presence of modal verbs, interrogative markers, and argument patterns. The server may compute a feature vector and feed it into a classification model or evaluate rule-based patterns. The server outputs an intent label, such as “schedule_change_request” or “directive”, and associated slot information, such as “target=meeting” and “attribute=time”.

### Step 8:

The server detects courtesy expressions and computes a respect feature vector. The input for this step is the dependency structure, the annotated token sequence, and the intent label. The server compares the analyzed sentence against a lexicon and rule set that defines honorific verbs, polite auxiliaries, sentence-final politeness markers, and indirect request constructions. The server scans tokens and dependency relations, and when a pattern matches (for example, a polite auxiliary or an interrogative request form), the server updates a feature vector by incrementing counts or setting binary flags for the corresponding courtesy category. The server outputs a respect feature vector that encodes the presence and types of courtesy expressions in the message.

### Step 9:

The server calculates a numerical respect score and assigns a categorical respect level. The input for this step is the respect feature vector from Step 8. The server applies a scoring function that multiplies each feature value by a corresponding weight and sums the products to obtain a raw score.

The server normalizes the raw score into a predefined range, such as 1 to 5, and compares the normalized score with threshold values to determine a categorical label like “low”, “medium”, or “high”. The server outputs a respect evaluation record containing at least the numerical score, the respect level label, and the underlying feature vector.

### Step 10:

The server generates a prompt sentence for a generative AI model based on the intent and respect evaluation. The input for this step is the user's original text, the intent label, and the respect evaluation record. The server selects a prompt template according to the type of task to be performed (for example, analysis only or analysis plus rewriting) and fills template placeholders with the dynamic values. The server concatenates fixed instruction text and the user's message, and may include the current respect score as context. For instance, the server generates a prompt sentence such as:

“Analyze the following user message and determine both the user's intent and the degree of respect expressed toward the recipient. Message: ‘Could you please change the meeting time?’. First, summarize the user's intent in one sentence. Second, rate the respect level on a scale from 1 (very low) to 5 (very high) and explain your reasoning briefly.”

The server outputs a complete prompt sentence as a text string suitable for input to the generative AI model.

### Step 11:

The server encodes and transmits the prompt sentence to the generative AI model. The input for this step is the prompt sentence produced in Step 10. The server uses a tokenizer associated with the generative AI model to convert the prompt sentence into a sequence of token identifiers. The server then packages the token sequence and model parameters such as maximum output length and temperature into a request structure. The server sends this request structure to the generative AI model, either via an internal function call if the model is hosted on the same machine or via an external application programming interface if the model is remote. The output of this step is a model inference request being submitted to the generative AI model.

### Step 12:

The server receives and decodes the response from the generative AI model. The input for this step is an output token sequence or text string generated by the generative AI model in response to the prompt. The server converts the token sequence back into a text string, if required, and then parses the text according to an expected format. For example, the server may look for delimiters or labels indicating a section containing an intent summary, a section containing a respect rating, and a section containing one or more polite rephrasings. The server performs string processing and simple pattern matching to segment the response into fields. The server outputs a parsed generative response record that includes structured elements such as “refined_intent_summary”, “refined_respect_score”, and “polite_rephrased_message_list”.

### Step 13:

The server integrates the deterministic analysis and the generative response. The input for this step is the intent label and respect evaluation record from Steps 7 and 9, and the parsed generative response record from Step 12. The server compares the numerical respect score and level from the deterministic evaluation with the refined respect score from the generative response. The server applies arbitration rules, such as averaging scores within a tolerance range or preferring the deterministic score if the discrepancy exceeds a threshold. The server selects or combines explanations and may select one or more polite rephrasings from the generative response. The server outputs an integrated result record that includes at least the final intent summary, final respect score and level, an explanation of the evaluation, and selected polite alternative expressions.

### Step 14:

The server generates a result payload for the terminal. The input for this step is the integrated result record from Step 13 and the original user message and metadata from the verified request record.

The server formats the information into a structured response that contains fields such as original_text, intent_summary, respect_score, respect_level, explanation, and polite_suggestions.

The server may also compute additional flags indicating whether the message is recommended for revision. The server outputs a response object and serializes it into a transferable format for network transmission to the terminal.

### Step 15:

The server transmits the result payload to the terminal. The input for this step is the serialized response object from Step 14. The server uses the communication network and protocol to send the response to the terminal address associated with the original request. The server sets appropriate headers and status codes to indicate successful processing. The output is a network message containing the result payload delivered to the terminal.

### Step 16:

The terminal receives and parses the result payload from the server. The input for this step is the network message containing the serialized response object. The terminal uses its communication stack to decode protocol headers and a parsing component to convert the serialized data back into an internal data structure. The terminal extracts fields such as intent_summary, respect_score, respect_level, explanation, and polite_suggestions. The terminal outputs a parsed result structure that can be consumed by the user interface layer.

### Step 17:

The terminal displays the analysis and suggestions to the user. The input for this step is the parsed result structure from Step 16. The terminal uses a graphical user interface framework to render the intent summary as text, show the respect score and level in numeric and categorical form, and list one or more polite suggestions as selectable items. The terminal may also highlight specific parts of the original text that were judged to affect the respect level. The terminal outputs a visual representation on the display, enabling the user to understand how the message is evaluated and what alternative expressions are available.

### Step 18:

The user interacts with the terminal to select or modify a polite suggestion. The input for this step is the displayed set of polite suggestions and the original message. The user may tap or click on a suggested expression to adopt it directly, or may use an editing interface to refine the suggestion.

The terminal captures the user's selection or edited text as new character information, and updates its internal message buffer accordingly. The terminal outputs an updated message that can be used for subsequent actions, such as sending the message to a counterpart through an external communication application.

### Step 19:

The terminal optionally forwards the updated message to an external communication service. The input for this step is the updated message selected or edited by the user in Step 18. The terminal may invoke an email client, messaging application, or other communication tool, passing the updated message as body text. The terminal performs data transfer to the external service using its communication interface. The output is a delivered message that reflects the respect-aware processing performed by the server.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional communication-support systems that perform sentiment analysis and natural language generation typically apply a fixed politeness filter or a static rephrasing rule to user messages. Such systems suffer from several technical limitations. First, they generally treat the user's input as a single, isolated text segment and do not normalize heterogeneous input modalities, such as speech and text, into a common internal representation in a manner that is tightly integrated with downstream language understanding and generation. This often leads to inconsistent interpretation when voice input is used, and increases processing latency and error rates in the downstream pipeline.

Second, known systems typically perform sentiment or emotion analysis in a one-shot manner, without maintaining a temporal model of the user's emotional state across a session. As a result, the systems cannot reliably track emotion change over time, and therefore cannot adapt the generation strategy of a language model to reflect the user's evolving state. This limitation causes generated messages to remain overly aggressive, overly apologetic, or otherwise inappropriate relative to the current conversation context.

Third, many existing generative text systems simply pass the raw user message to a generative model, with minimal prompt engineering. They do not systematically incorporate structured information such as (a) evaluated user intent, (b) degree of consideration toward the counterpart, and (c) emotion change history into a prompt sentence. This leads to unstable output behavior of the generative model, because it receives under-specified instructions and is forced to infer missing constraints from ambiguous text. In addition, such systems rarely perform a second-stage refinement of the generated text, driven explicitly by detected emotion changes, which reduces their ability to dynamically adjust writing style and politeness level during an ongoing dialogue.

From a computer-technology perspective, these limitations manifest as suboptimal use of processing resources and model capabilities. The system does not structurally coordinate input normalization, linguistic analysis, emotion tracking, and prompt construction, and therefore fails to stabilize the generative model's behavior and to reduce the need for repeated user edits. There is thus a need for a system and computer-implemented method that: (i) unifies heterogeneous user inputs into a normalized character-based representation; (ii) performs integrated linguistic and emotion analysis, including tracking of emotion changes over time; and (iii) constructs and iteratively refines prompt sentences for a generative AI model so that the model can generate counterpart-respecting expressions in a manner that adapts to the user's intent and evolving emotional state.

The specific processing by the specific processing unit 290 of the data processing device 12 in Application Example 2 is realized by the following means.

The present invention provides a server comprising a processor configured to receive input information from a user via one or more client devices, normalize the input information into character information including converting voice information into character information, perform natural language processing including morphological analysis and syntactic analysis on the normalized character information to evaluate a speaking intention of the user and a degree of consideration toward a counterpart, estimate an emotional state of the user by applying an emotion analysis technique to the character information, record temporal changes of the estimated emotional state on a per-user or per-dialogue basis, identify an emotion change based on the recorded temporal changes, generate a first prompt sentence for input to a generative artificial intelligence model based on at least the evaluated speaking intention, the evaluated degree of consideration toward the counterpart, the estimated emotional state, and the identified emotion change, cause the generative artificial intelligence model to generate, in response to the first prompt sentence, at least one of a counterpart-respecting expression and a response content corresponding to the input information of the user, generate an additional prompt sentence for readjusting at least one of a writing style and a degree of consideration of the generated counterpart-respecting expression or the generated response content in accordance with the identified emotion change, cause the generative artificial intelligence model to operate again in response to the additional prompt sentence to obtain an adjusted expression, and provide the adjusted expression as output information that is presentable to the user. This enables coordinated improvement of the overall computer processing pipeline by unifying multimodal input into a stable textual representation, by explicitly modeling and tracking user emotion over time, and by structurally encoding intent, consideration level, and emotion change into prompt sentences for a generative AI model, thereby stabilizing the model's output behavior, reducing user-side correction operations, and improving the efficiency and technical reliability of computer-implemented communication support.

The term “processor” refers to a hardware or virtual processing unit, such as a central processing unit, a graphics processing unit, or another programmable computation resource, that executes instructions to perform the functions described in the present disclosure.

The term “input information” refers to data provided by a user to the system, including but not limited to character information, voice information, or other symbolic information that represents a message, opinion, request, or other communicative content.

The term “user” refers to an individual or an entity that provides the input information to the system and receives output information from the system.

The term “character information” refers to information expressed in a textual form using characters of a writing system, such as alphabetic characters, ideographic characters, or other machine-readable symbols.

The term “voice information” refers to acoustic data representing spoken utterances of the user, including analog or digitized audio signals captured by an input device such as a microphone.

The term “normalize” refers to processing that converts heterogeneous forms of input information, including voice information and pre-existing character information, into a unified internal representation as character information suitable for subsequent analysis.

The term “natural language processing” refers to a series of computational techniques for analyzing human language, including operations such as tokenization, morphological analysis, syntactic analysis, and other linguistic analyses performed on character information.

The term “morphological analysis” refers to a process that segments character information into tokens and determines linguistic attributes of the tokens, such as part-of-speech categories, base forms, or inflectional features.

The term “syntactic analysis” refers to a process that determines structural relationships among tokens in character information, such as dependency relations, phrase structures, or clause boundaries.

The term “speaking intention” refers to an intent or communicative goal of the user inferred from the input information, such as complaint, request, proposal, criticism, explanation, or another type of communicative act.

The term “degree of consideration toward a counterpart” refers to a level of politeness, respect, or social appropriateness expressed toward a communication partner as estimated from the input information.

The term “counterpart” refers to any individual or entity that is the intended recipient or subject of the user's communication, such as a superior, a subordinate, a colleague, a customer, or another communication partner.

The term “emotion analysis technique” refers to a computational technique or model that estimates an emotional state from character information, including but not limited to methods based on statistical analysis, machine learning, or rule-based classification.

The term “emotional state” refers to an internal affective condition of the user inferred from the input information, such as anger, frustration, dissatisfaction, calmness, anxiety, or other emotional categories or dimensions.

The term “temporal change of the emotional state” refers to a variation of the estimated emotional state over time within a session, dialogue, or series of interactions associated with the same user.

The term “emotion change” refers to a difference between at least two emotional states of the user estimated at different time points, indicating a transition such as from anger to calmness or from dissatisfaction to acceptance.

The term “generative artificial intelligence model” refers to a trained computational model configured to generate text or other content based on an input, such as a neural network language model that produces character sequences conditioned on a prompt.

The term “generative text processing” refers to a processing operation in which a generative artificial intelligence model produces new textual content based on an input condition, such as a prompt sentence or other control information.

The term “prompt sentence” refers to character information that encodes instructions, constraints, context, or other conditioning information for a generative artificial intelligence model, and that is used to guide the model's generation of output text.

The term “counterpart-respecting expression” refers to a textual expression generated or selected so as to convey the user's intention while maintaining a degree of politeness, respect, or consideration toward the counterpart that satisfies a predetermined or dynamically determined criterion.

The term “response content” refers to textual output generated for use as a reply or reaction to the user's input information, including explanations, apologies, proposals, or other communicative responses.

The term “writing style” refers to a set of textual characteristics of an expression, including but not limited to tone, politeness level, formality, sentence length, and choice of lexical items.

The term “degree of consideration” refers to a quantitative or qualitative indication of politeness, respect, or attentiveness encoded in a textual expression, as determined by the system based on the emotion change or other contextual factors.

The term “additional prompt sentence” refers to a prompt sentence generated after an initial generation process, used to instruct the generative artificial intelligence model to modify or refine previously generated text, including adjustment of writing style and degree of consideration.

The term “adjusted expression” refers to a textual expression that results from applying the generative artificial intelligence model in response to the additional prompt sentence, and that has been modified to reflect the identified emotion change or other updated constraints.

The term “output information that is presentable to the user” refers to information, including the adjusted expression or associated metadata, formatted so that it can be displayed or otherwise presented to the user by an output device such as a display unit, a speaker, or another user interface component.

The term “client device” refers to an information processing apparatus operated by the user to transmit the input information to the server and to receive the output information from the server, such as a mobile terminal, a wearable device, or a general-purpose computing device.

In one embodiment, a server executes a communication support program on a general-purpose computing platform. The server comprises at least one processor, a main memory, a nonvolatile storage device, and a network interface. The server runs an operating system such as a general-purpose server operating system and hosts one or more application processes. The server provides an application programming interface (API) accessible over a communication network. A terminal operated by a user communicates with the server via the communication network. The terminal is realized as an information processing apparatus such as a smartphone, a tablet, a wearable device, or a personal computer.

The server stores, in the nonvolatile storage device, a set of program modules including at least: an input normalization module, a linguistic analysis module, an intent and respect evaluation module, an emotion analysis and tracking module, a prompt generation module, a generative AI interface module, a refinement control module, and an output formatting module. The server further stores, in the nonvolatile storage device, trained parameters of one or more neural network models including at least one encoder-type model for classification and at least one decoder-type or encoder-decoder-type model for text generation. The server loads the program modules and model parameters into the main memory at runtime.

The terminal runs a client application or a web browser that presents a user interface for acquiring user input information and for displaying output information generated by the server. The user inputs information in the form of text or speech. The terminal converts speech to digital audio signals using a microphone and transmits the signals or pre-transcribed text data to the server via the network interface. The terminal optionally presents metadata selection elements, for example to allow the user to specify an attribute relationship such as “superior,” “subordinate,” “customer,” or “colleague.”

The server uses an input normalization module to convert heterogeneous input modalities into a unified character information representation. When the user sends speech, the server invokes a speech recognition component. In one embodiment, the server uses a cloud-based automatic speech recognition service, which internally employs an acoustic model and a language model implemented as deep neural networks, to transform waveform data into a sequence of characters or words. The server thereby reduces modality-dependent variation and ensures that downstream natural language processing modules receive a consistent character-based input. By performing input normalization at the server side, the system reduces duplication of speech processing logic across multiple terminals and centralizes accuracy improvements in a single component.

The server uses a linguistic analysis module to perform morphological analysis and syntactic analysis on the normalized character information. In one embodiment, the server employs a natural language processing library that performs tokenization, part-of-speech tagging, lemmatization, and dependency parsing. The server represents the analysis result in a structured data format, for example as a token list where each token stores attributes such as surface form, lemma, part-of-speech tag, dependency head index, and dependency label. The server further stores clause boundaries and sentence segmentation as part of this structure. This structured representation allows the server to derive features such as the presence of modality markers, direct second-person references, and negative polarity, which are used downstream for intent and respect evaluation.

The server uses an intent and respect evaluation module to evaluate a speaking intention and a degree of consideration toward a counterpart. In one embodiment, the server applies a neural network classifier based on a transformer encoder architecture. The classifier receives as input a sequence of token embeddings. Each token embedding is constructed by summing a token representation, a positional representation, and optionally a segment representation. The classifier comprises multiple self-attention layers, each including multi-head attention and feedforward sublayers with residual connections and normalization. The classifier outputs a fixed-length vector corresponding to a special classification token. The server applies one or more fully connected layers and a softmax function to this vector to obtain probability distributions over predefined intent classes (such as “complaint,” “request,” “criticism,” “feedback”) and over predefined respect levels (such as “low respect,” “neutral,” “polite”).

The server stores the intent and respect inference results in a session record associated with the user and the ongoing dialogue. The server thereby maintains a machine-readable representation of the user's communicative goal and politeness state, rather than relying solely on raw text. This structured representation allows the prompt generation module to incorporate explicit constraints into a prompt sentence and reduces the generative model's burden of inferring the entire context from ambiguous content.

The server uses an emotion analysis and tracking module to estimate an emotional state of the user and to track temporal changes of the emotional state. In one embodiment, the server employs an emotion classifier implemented as a neural network that shares a similar transformer encoder architecture with the intent classifier but is fine-tuned using labeled emotion data. The server feeds the normalized character information into the emotion classifier and obtains a probability distribution across emotion labels such as “anger,” “frustration,” “dissatisfaction,” “calmness,” and “sadness.” The server selects the emotion label with the highest probability and stores both the label and the probability vector.

The server maintains an emotion history for each user or dialogue. The server stores, in a database, a sequence of emotion records each containing at least: a timestamp, an emotion label, a confidence score, and a reference to the associated input information. The server uses this sequence to compute an emotion change. For example, when the most recent emotion label differs from the previous label and the change exceeds a configured threshold, the server identifies a transition, such as a change from “anger” to “calmness.” The server then marks this transition as emotion change data. By explicitly tracking emotion change, the server can alter the generative processing behavior over time, rather than applying a static style filter.

The server uses a prompt generation module to construct a prompt sentence that controls a generative AI model. The prompt generation module integrates several types of information: the normalized character information, the evaluated speaking intention, the evaluated degree of consideration, the estimated emotional state, the emotion change data, and context information such as the relationship type and application domain. The server uses predefined templates or rule-based composition logic to generate prompt sentences.

In one example, when the user writes “I think his proposal is wrong” and the classifier outputs an intent of “criticism,” a respect level of “neutral,” an emotion label of “anger,” and a relationship type of “superior,” the server constructs a prompt sentence such as:
“The user wrote: “I think his proposal is wrong.”
Intent: criticism.
Current emotion: anger.
Relationship: the other person is the user's superior.
Task: Rewrite the user's content as a respectful and professional sentence that still conveys the main concern, suitable for communication with a superior. Output only the revised sentence.”

In another example, when the user writes “The payment is not working” and the classifier outputs an intent of “complaint” with an emotion label of “dissatisfaction,” the server constructs a prompt sentence such as:
“Customer message: “The payment is not working.”
Detected intent: complaint about a payment failure.
Detected emotion: dissatisfaction.
Task: As a polite support agent, generate a respectful response that apologizes for the inconvenience and offers concrete next steps to solve the issue. Output only the response text.”

The server uses a generative AI interface module to communicate with a generative AI model. In one embodiment, the generative AI model is realized as a transformer-based autoregressive language model trained on large-scale text data. The model comprises a stack of self-attention layers that compute, for each output position, a probability distribution over possible next tokens conditioned on previous tokens and the prompt sentence. The server supplies the prompt sentence to the model and configures parameters such as maximum output length, sampling temperature, and top-k or top-p sampling thresholds. The server calls the model through an application programming interface and receives a generated character sequence representing a counterpart-respecting expression or response content.

The server uses a refinement control module to adjust the generated text based on emotion change. When the emotion analysis and tracking module has detected a meaningful transition in emotional state, the server constructs an additional prompt sentence that references both the originally generated text and the new emotion state. For example, if the user's emotion changed from “anger” to “calmness” between two inputs, and the first generated version was “We might need to reconsider his proposal,” the server constructs an additional prompt sentence such as: “Original user input: “I think his proposal is wrong.”
Initial emotion: anger.
Updated emotion: calmness.
First rewritten version: “We might need to reconsider his proposal.”
Task: Adjust the rewritten version to match a calmer and more neutral tone while keeping the same meaning. Output only the adjusted sentence.”

The generative AI interface module then sends this additional prompt sentence to the generative AI model. The model generates an adjusted expression, for example, “His proposal may be worth reconsidering from another perspective.” The refinement step allows the system to update style and politeness in a manner that follows the technical state of the emotion tracking mechanism, rather than requiring manual intervention.

The server uses an output formatting module to produce output information that is presentable to the user. The server combines the adjusted expression with optional analysis information such as the detected intent, the respect level, and the emotion label. The server converts this data into a response format suitable for the terminal, for example a structured text message that the terminal displays in a dialogue user interface. The server also stores the interaction in a log structure that includes, among other fields, the original input information, the prompt sentences, the generative model outputs, and the selected adjusted expression. This log structure supports further analysis and tuning of the system.

The user receives the adjusted expression on the terminal. The terminal displays both the original text and the generated counterpart-respecting expression, or only the generated expression in a real-time wearable scenario. The user uses the generated expression as is or edits it manually before sending it to a counterpart. In a face-to-face scenario with a wearable device, the user reads the displayed phrase and speaks it aloud. In this way, the system actively supports communication in real-world interactions, rather than functioning merely as an offline text editor.

From a technical viewpoint, this configuration improves computer technology beyond straightforward automation of human rewriting. The server coordinates multiple specialized modules—input normalization, linguistic analysis, neural classification, temporal emotion tracking, template-based prompt construction, and neural generation-through well-defined data structures. The server thereby reduces the search space that the generative AI model must explore, because the prompt sentence encodes explicit constraints derived from structured analysis. This reduces unnecessary sampling operations and shortens generation time, which leads to improved processing speed on the computing platform.

Furthermore, the emotion tracking mechanism provides stateful information that is not naturally available to a human performing ad-hoc rewriting. The server exploits this stateful information to determine when and how to invoke the generative model a second time for refinement. By avoiding redundant re-generation in the absence of significant emotion change, the server reduces computation cost and network traffic. When emotion change occurs, the server guides the generative model with focused additional prompt sentences that reuse the first generation result, increasing convergence speed and reducing variance in outputs.

The neural models themselves are implemented using well-defined training procedures. In one embodiment, the server trains the intent and respect classifier using supervised learning with a cross-entropy loss function applied to the intent and respect labels. The server updates model weights by stochastic gradient descent or an adaptive variant. The emotion classifier is trained similarly using emotion labels. The generative model is pre-trained on large text corpora using a next-token prediction objective and optionally fine-tuned on dialogue data or politeness-focused data. The training phase may include data augmentation procedures such as paraphrasing or noise injection, which increase model robustness. By explicitly disclosing the use of these architectures, objectives, and optimization methods, the system provides a concrete technical implementation rather than an abstract reference to “AI processing.”

The server in various embodiments uses specific rule sets for mapping classification outputs to prompt components. For example, when the degree of consideration is “low respect,” the server adds explicit instructions such as “increase politeness and avoid direct blame expressions” to the prompt sentence. When the intent is “request” and the counterpart is a “superior,” the server instructs the model to “use a deferential register and avoid imperative forms.” These rules implement a nonconventional combination of symbolic control logic with neural generation, enabling the system to constrain the generative model in a manner that yields stable, context-appropriate text while preserving flexibility in wording.

In another embodiment, the server runs on a distributed computing environment in which the neural models are deployed on a dedicated accelerator device such as a graphics processing unit. The server schedules batches of prompt sentences from multiple users and executes them in parallel on the accelerator device. By leveraging batch processing and shared model weights, the server increases throughput while keeping latency per user below a target threshold. This architectural design contributes to efficient resource utilization and improved scalability, which are technical improvements to the operation of the computing system.

In still another embodiment, the terminal executes a lightweight pre-processing module that performs partial linguistic analysis or preliminary emotion estimation. The terminal transmits the preliminary analysis results to the server along with the raw character information. The server uses these pre-computed features to reduce redundant computations in the linguistic analysis and emotion analysis modules. This division of labor between terminal and server allows the system to adapt to different network conditions and device capabilities, further enhancing technical performance.

The system is not limited to a particular kind of communication context. In one embodiment, the server integrates with a personnel management support platform. The server receives internal communication drafts and produces adjusted expressions that maintain professionalism and respect.

In another embodiment, the server integrates with a communication tool that includes an automatic response function, so that the server generates or refines automatic replies in customer support chats.

In each case, the core technical processing-input normalization, structured analysis, stateful emotion tracking, constraint-based prompt generation, and neural text generation with refinement-remains the same.

Through these embodiments, the server, the terminal, and the user cooperate to implement the claimed system in a manner that can be realized on practical computing hardware. The server applies specific data structures, algorithms, and neural network architectures to process input information and to generate counterpart-respecting expressions. The server thereby achieves improvements in processing speed, stability, and accuracy relative to systems that do not combine structured analysis, emotion tracking, and controlled prompt sentences for a generative AI model.

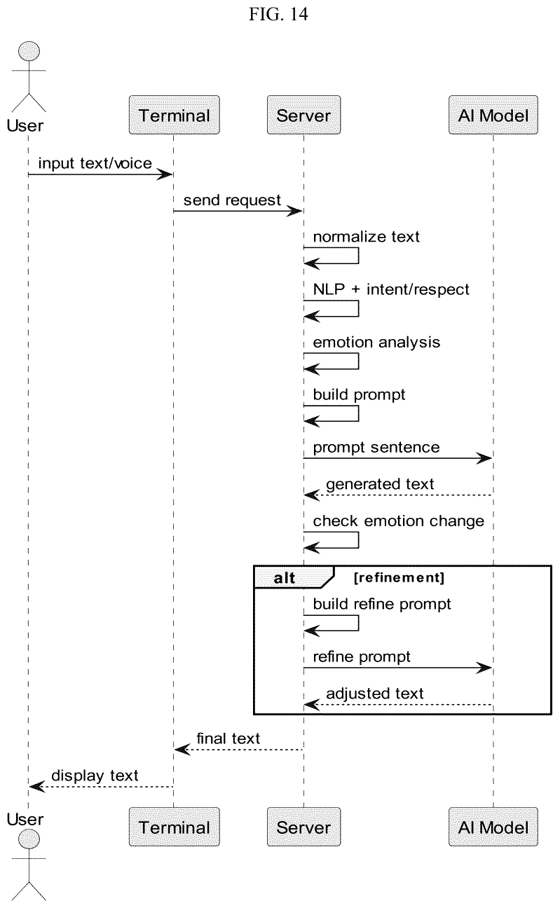

The following describes the processing flow using FIG. 14.

### Step 1:

User provides input information via the terminal.

User enters text such as “I think his proposal is wrong” or speaks a sentence such as “The payment is not working” into the terminal. The input is either a character string captured from a text field or an audio signal captured from a microphone.
Input: raw text data and/or raw audio data, plus optional metadata such as relationship type and context.
Output: a user input object on the terminal containing the raw text or audio buffer and metadata.

### Step 2:

Terminal transmits the input information to the server.

Terminal packages the user input object into a network request, for example an HTTP POST request to an API endpoint exposed by the server. Terminal encodes metadata fields such as user identifier, timestamp, and relationship attributes into a structured payload.
Input: user input object including raw text or audio and metadata.
Output: a network message containing the input information delivered to the server via a communication interface.

### Step 3:

Server normalizes the input into character information.

Server inspects the received payload and determines whether the primary content is text or audio. If the content is audio, server invokes a speech recognition component to convert waveform samples into a sequence of tokens and then into a normalized character string. If the content is already text, server cleans the text by removing control characters and normalizing character encodings.
Input: raw text or audio data and metadata from the network message.
Output: normalized character information representing the user's message in a unified textual format.

### Step 4:

Server performs linguistic analysis on the normalized character information.

Server applies a natural language processing library to tokenize the character information into words or subword units, assign part-of-speech tags, and compute syntactic dependencies. Server stores the result in a structured data record where each token includes indices, lexical attributes, and syntactic relations. Server additionally marks sentence boundaries and clause structures.
Input: normalized character information.
Output: a linguistic analysis record including a token list with part-of-speech tags, dependency relations, and sentence segmentation.

### Step 5:

Server evaluates speaking intention and degree of consideration toward the counterpart.

Server converts the tokenized text into numerical embeddings and feeds them into a transformer-based classifier. Server performs forward propagation through self-attention layers to obtain a context-sensitive representation of the entire message. Server applies classification layers and a softmax function to compute probability distributions for intent classes and respect-level classes.

Server then selects the most probable intent label and respect-level label and records their confidence scores.
Input: linguistic analysis record and token sequence.
Output: an intent label, a degree-of-consideration label, and corresponding confidence scores stored in an intent/respect evaluation record.

### Step 6:

Server estimates the user's emotional state.

Server feeds the same or similar token sequence into an emotion classifier implemented as a neural network. Server computes hidden representations via attention layers and outputs a probability distribution across predefined emotion categories. Server identifies the emotion label with the highest probability, such as “anger” or “dissatisfaction,” and stores the full probability vector for later analysis.
Input: normalized character information and token sequence.
Output: an emotion record containing an emotion label, a confidence score, and a probability distribution.

### Step 7:

Server tracks temporal changes of the emotional state.

Server retrieves previous emotion records for the same user or dialogue from a persistent storage device. Server compares the current emotion vector with the previous one, for example by subtracting probability values and computing a difference metric. Server interprets a significant change in the dominant label or probability distribution as an emotion change, such as a transition from “anger” to “calmness.” Server writes an updated emotion history to the database including the new emotion record and, if applicable, a transition descriptor.
Input: current emotion record and previous emotion records for the user or dialogue.
Output: an updated emotion history and an emotion change descriptor indicating whether and how the emotional state has changed over time.

### Step 8:

Server constructs a primary prompt sentence for the generative AI model.

Server aggregates the normalized character information, the intent label, the respect-level label, the current emotion label, the emotion change descriptor, and metadata such as relationship type and application context. Server applies template rules to embed these elements into a human-readable instruction text. For example, server generates:
“The user wrote: “I think his proposal is wrong.”
Intent: criticism.
Current emotion: anger.
Relationship: the other person is the user's superior.
Task: Rewrite the user's content as a respectful and professional sentence that still conveys the main concern, suitable for communication with a superior. Output only the revised sentence.”
Input: normalized character information, intent/respect evaluation record, emotion record, emotion change descriptor, and metadata.
Output: a primary prompt sentence string prepared for input to the generative AI model.

### Step 9:

Server invokes the generative AI model with the primary prompt sentence.

Server submits the primary prompt sentence to a generative AI model interface and sets generation parameters such as maximum length and sampling temperature. Server causes the model to perform autoregressive decoding conditioned on the prompt sentence, computing token probabilities and sampling or selecting tokens iteratively to form an output sequence. Server receives a generated text sequence that represents an initial counterpart-respecting expression or response content.
Input: primary prompt sentence and model configuration parameters.
Output: an initially generated text expression produced by the generative AI model.

### Step 10:

Server decides whether refinement based on emotion change is required.

Server examines the emotion change descriptor from the emotion history and a rule set defining thresholds and conditions. If the descriptor indicates a significant change in emotional state, server determines that refinement is required. If no significant change is found, server marks the initial generated text as final for this iteration.
Input: emotion change descriptor and initially generated text expression.
Output: a refinement decision flag indicating whether an additional generation step should be performed.

### Step 11:

Server constructs an additional prompt sentence for refinement when required.

Server, if refinement is needed, composes an additional prompt that includes the original user input, the initial generated text, the initial and updated emotion labels, and explicit instructions for tone adjustment. For example, server generates:
“Original user input: “I think his proposal is wrong.”
Initial emotion: anger.
Updated emotion: calmness.
First rewritten version: “We might need to reconsider his proposal.”
Task: Adjust the rewritten version to match a calmer and more neutral tone while keeping the same meaning. Output only the adjusted sentence.”
Input: original normalized character information, initially generated text expression, initial emotion record, and updated emotion record.
Output: an additional prompt sentence string for refinement by the generative AI model.

### Step 12:

Server obtains an adjusted expression using the generative AI model.

Server submits the additional prompt sentence to the generative AI model and triggers another generation pass. Server allows the model to reuse internal language knowledge while focusing on the constraints encoded in the additional prompt. Server collects the resulting adjusted text, which reflects the requested change in writing style and degree of consideration.
Input: additional prompt sentence.
Output: an adjusted text expression that incorporates emotion-based refinement.

### Step 13:

Server formats and returns output information to the terminal.

Server selects either the initially generated text or the adjusted expression as final, depending on the refinement decision. Server packages the final expression together with optional analytical data, such as intent, respect level, and emotion, into a response payload. Server converts this payload into a format consumable by the terminal and sends it via the network interface.
Input: final text expression and associated analysis records.
Output: a structured response message transmitted to the terminal containing the final counterpart-respecting expression or response content.

### Step 14:

Terminal presents the output information to the user.

Terminal receives the response message from the server and parses the payload. Terminal displays the final expression on a user interface element such as a chat window, an email draft pane, or a wearable display. Terminal optionally shows the original input alongside the suggested expression and provides controls to accept, edit, or regenerate the suggestion.
Input: structured response message from the server.
Output: visual or auditory presentation of the final expression to the user and, optionally, user interaction events indicating acceptance or modification.

### Step 15:

User utilizes the generated expression for communication.

User reviews the displayed counterpart-respecting expression and decides how to apply it. User may directly send the generated message to a counterpart through a communication application on the terminal, edit the text to add domain-specific details, or speak the phrase aloud in a face-to-face interaction.
Input: displayed final expression and available user interface controls.
Output: a selected communication action performed by the user, such as transmission of a refined message or delivery of an adjusted spoken expression.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent.

Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

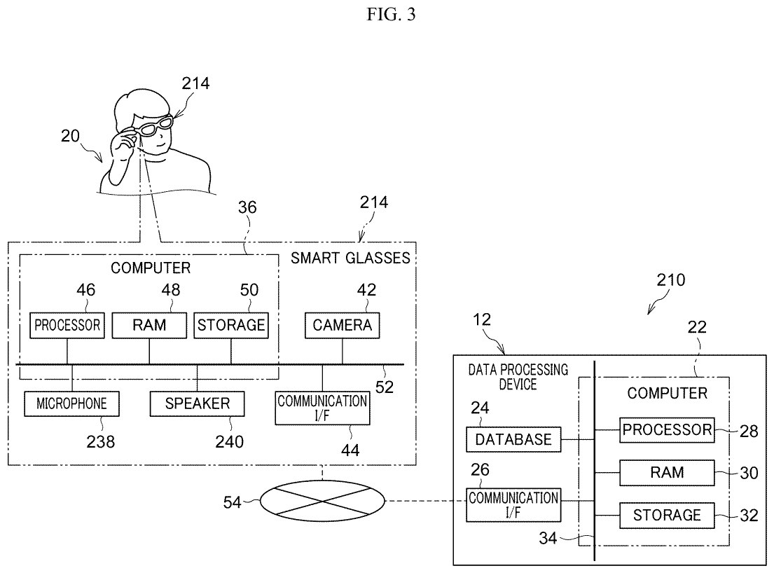

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50.

The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

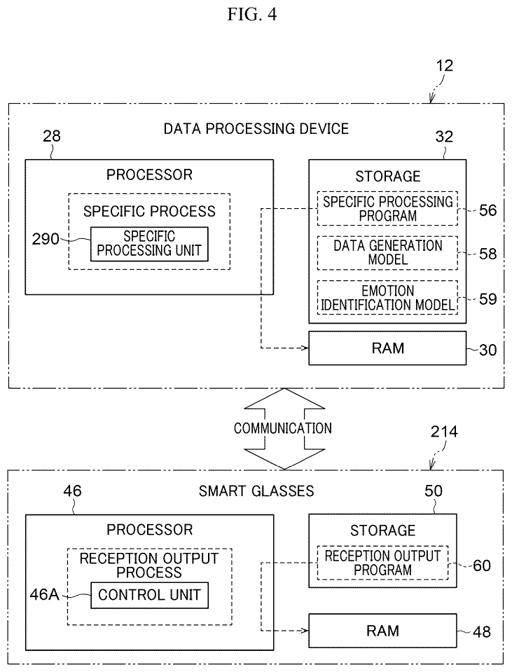

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

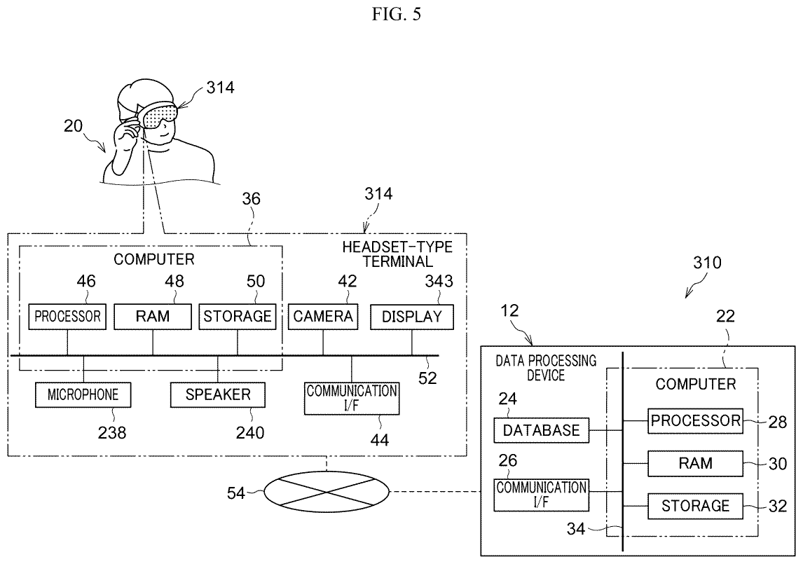

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

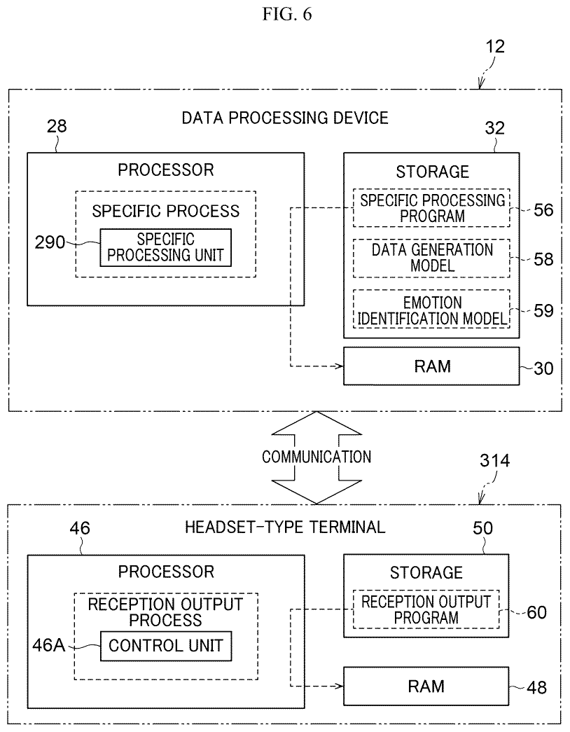

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

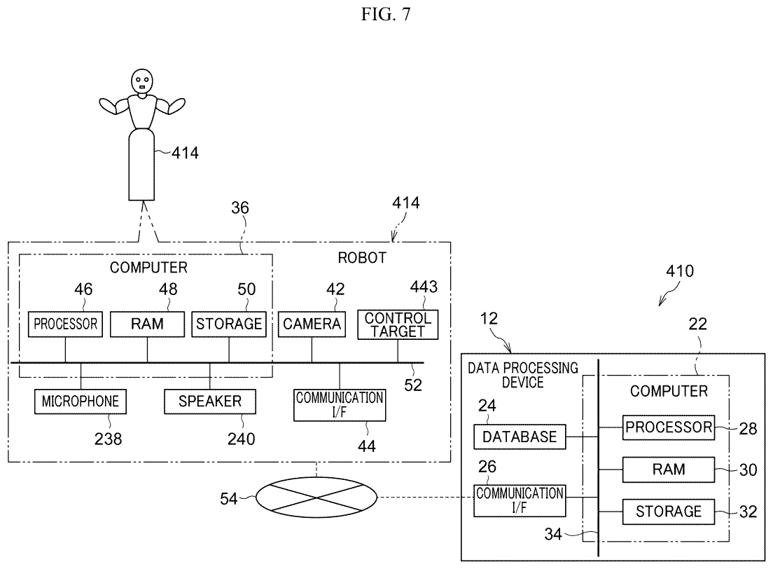

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

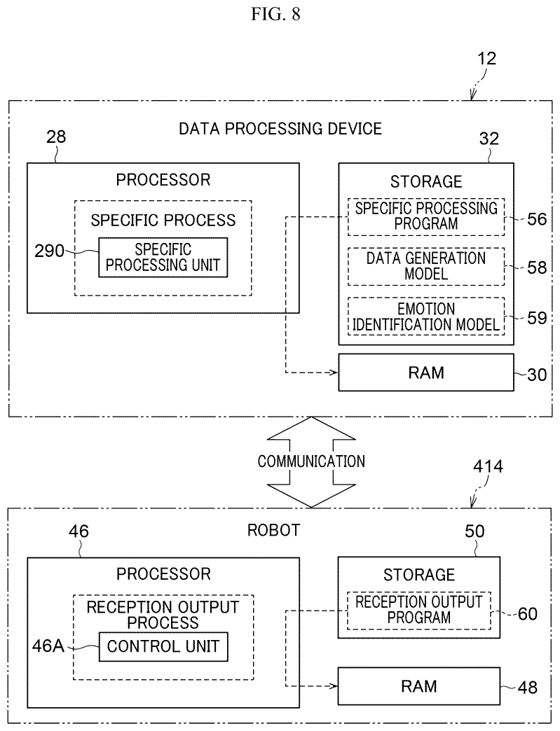

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

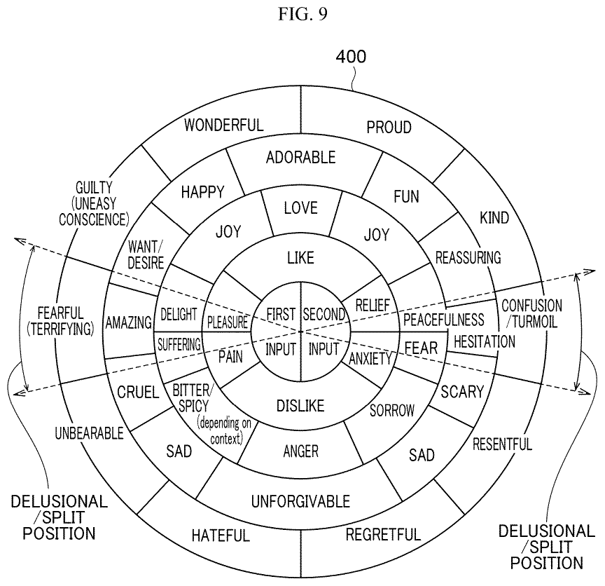

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

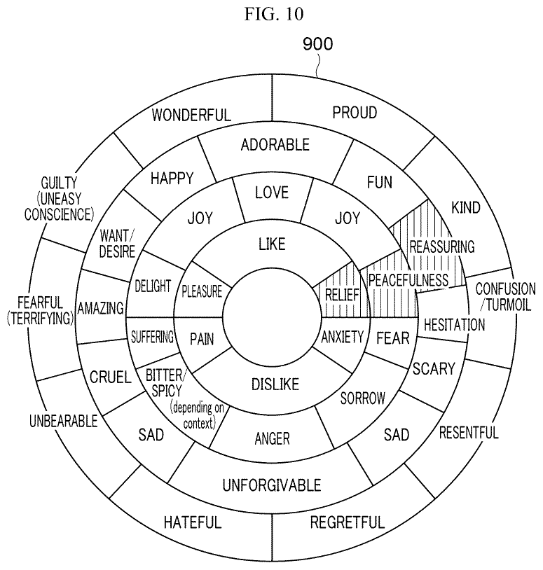

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive input information from a user, the input information including an opinion of the user and a relationship between the user and a target of the opinion; and
convert the input information into a structured information format and transmit the structured information format to an information processing apparatus by using a secure communication method; and
in the information processing apparatus, analyze the structured information format and generate a prompt sentence in a natural language to be input to a generative AI model based on the opinion and the relationship included in the input information; and
in the information processing apparatus, input the prompt sentence to the generative AI model and cause the generative AI model to generate a natural language expression representing an appropriate communication method corresponding to the opinion and the relationship; and
in the information processing apparatus, convert the generated natural language expression into the structured information format and transmit the structured information format to a user-side apparatus by using the secure communication method; and
in the user-side apparatus, analyze the structured information format and output the generated natural language expression to a display device.

### (Supplementary 2)

The system according to supplementary 1,
wherein the processor is configured to
generate the prompt sentence by inserting the opinion and the relationship into a predefined template of the prompt sentence, the predefined template including an instruction that the generative AI model output a respectful expression toward a counterpart and specific example sentences of the communication method based on the opinion and the relationship.

### (Supplementary 3)

The system according to supplementary 1,
wherein the processor is configured to
control the system so that the system is incorporated into a management tool for improving operation and interpersonal communication in an organization, or is used as an automatic response function of communication software.

### Application Example 1

### (Supplementary 1)

A system comprising a processor,
wherein the processor is configured to
receive input information from a user by using an information acquisition unit,
analyze the input information by using a natural language processing technique so as to evaluate an intention of the user and a degree of consideration for a counterpart,
acquire image data from an image acquisition device and recognize a facial expression of a person included in the image data by using an image processing technique and a classification model so as to generate expression data indicating an emotional state of the person,
integrate situation information including the intention of the user, a relationship with the counterpart, and the expression data, and generate a prompt sentence for input to a generative artificial intelligence model on the basis of the situation information,
transmit the prompt sentence to an external generative artificial intelligence model and receive a response sentence generated by the external generative artificial intelligence model, adjust content of the response sentence on the basis of evaluation criteria relating to consideration for the counterpart, politeness, and appropriateness of wording so as to generate an output sentence obtained by converting the intention of the user into an expression that respects the counterpart, and transmit the output sentence to a terminal device and cause the output sentence to be presented to the user through the terminal device.

### (Supplementary 2)

The system according to supplementary 1,
wherein the processor is configured to
generate the situation information in consideration of the input information including an honest feeling of the user and the relationship with the counterpart, and control a degree of respect, a level of politeness, and content of a proposal in the prompt sentence and the output sentence in accordance with the relationship with the counterpart.

### (Supplementary 3)

The system according to supplementary 1,
wherein the processor is configured to
be incorporated into an information processing apparatus for supporting dialogue in face-to-face service operations, continuously acquire changes in the facial expression of the counterpart through the image acquisition device while the user is responding face-to-face, and sequentially update the prompt sentence and the output sentence on the basis of temporal changes in the expression data.

### Example 2

### (Supplementary 1)

A system comprising a processor,
wherein the processor is configured to
receive, via a terminal, input information including character information from a user,
receive, via a communication network, the input information and analyze the input information by using a natural language processing technique to perform segmentation into lexical units, assignment of grammatical categories, and analysis of syntactic structure, thereby specifying a semantic structure of the input information and an intent of the user,
determine, on the basis of the semantic structure and the intent of the user, presence and degree of courtesy expressions including honorific expressions, polite expressions, and indirect request expressions, and evaluate a degree of respect for a counterpart as a numerical value or a category,
generate, on the basis of an evaluation result of the degree of respect and a result of specifying the intent of the user, a prompt sentence that instructs a generative information processing model to perform at least one of: conversion of the input information into an expression that respects the counterpart while maintaining the intent of the user, generation of an explanation of the degree of respect for the counterpart, and generation of an alternative expression having a higher level of courtesy,
transmit the prompt sentence to the generative information processing model and acquire, from the generative information processing model, response information including at least one of: a summary of the intent regarding the input information, an evaluation result of the degree of respect for the counterpart, and conversion information obtained by converting the input information into the expression that respects the counterpart,
integrate an evaluation result obtained by the natural language processing technique and the response information acquired from the generative information processing model, and generate result information including at least the intent of the user, the degree of respect for the counterpart, and the expression that respects the counterpart, and
transmit the result information to the terminal so that the terminal presents, to the user, at least a summary of the intent, the degree of respect for the counterpart, and the expression that respects the counterpart.

### (Supplementary 2)

The system according to supplementary 1,
wherein the processor is configured to
cause the system to present, as at least part of the result information, the evaluation result of the degree of respect for the counterpart with respect to the input information and a plurality of candidate expressions generated by the generative information processing model as the expression that respects the counterpart, and to enable correction of the input information on the basis of a selection operation by the user on at least one of the plurality of candidate expressions.

### (Supplementary 3)

The system according to supplementary 1,
wherein the processor is configured to
be used as a support function for dialogue management in an operation processing apparatus or a communication processing apparatus of an organization, or to be used as a function for automatic response processing in an electronic communication service.

### Application Example 2

### (Supplementary 1)

A system comprising a processor,
wherein the processor is configured to
receive input information from a user,
normalize the input information into character information, including converting voice information into character information,
perform natural language processing including morphological analysis and syntactic analysis on the normalized character information to evaluate a speaking intention of the user and a degree of consideration toward a counterpart,
estimate an emotional state of the user for the character information by using an emotion analysis technique, record a temporal change of the emotional state for each user or for each dialogue, and identify an emotion change based on the record,
generate a prompt sentence, for input to a generative artificial intelligence model that performs generative text processing, based on the speaking intention, the degree of consideration toward the counterpart, the emotional state, and the emotion change,
cause the generative artificial intelligence model to generate, in response to the prompt sentence, at least one of a counterpart-respecting expression and a response content corresponding to the input information of the user,
generate an additional prompt sentence for readjusting at least one of a writing style and a degree of consideration of the generated counterpart-respecting expression or the generated response content in accordance with the emotion change, and cause the generative artificial intelligence model to operate again to obtain an adjusted expression, and
provide the adjusted expression as output information that is presentable to the user.

### (Supplementary 2)

The system according to supplementary 1,
wherein the processor is configured to perform the evaluation of the speaking intention and the degree of consideration toward the counterpart and to generate the prompt sentence in consideration that the input information from the user includes a direct opinion content of the user and an attribute relationship with the counterpart.

### (Supplementary 3)

The system according to supplementary 1,
wherein the processor is configured to integrate the system into an information processing apparatus for personnel management support in an organization, or to use the system as an automatic response function of an information exchange program having a dialogue processing function.

What is claimed is:

1. A system comprising:
circuitry configured to
receive, via a packet-switched network, an input character sequence from a terminal device,
apply a natural language processing pipeline to the input character sequence, the natural language processing pipeline comprising tokenization into lexical units, assignment of grammatical category labels, and construction of a syntactic dependency structure,
compute, from the syntactic dependency structure and the lexical units, an intent classification label and a conformance score indicating a degree to which the input character sequence satisfies contextual adjustment criteria associated with a target entity,
generate, based on the intent classification label and the conformance score, a structured input sequence for a generative neural network model, the structured input sequence encoding at least the input character sequence, the intent classification label, and the conformance score into a formatted instruction that causes the generative neural network model to produce an output character sequence representing a contextually adjusted version of the input character sequence, and
transmit, via the packet-switched network, the output character sequence to the terminal device for rendering on a display of the terminal device.

2. The system according to claim 1, wherein the circuitry is further configured to:
extract, from the syntactic dependency structure, a feature vector comprising binary indicators corresponding to detected linguistic marker categories present in the input character sequence, and
compute the conformance score as a weighted sum of the binary indicators multiplied by stored weight parameters, and normalize the weighted sum to a predetermined numerical range.

3. The system according to claim 2, wherein the detected linguistic marker categories comprise at least one of honorific verb forms, polite auxiliary tokens, indirect request constructions, and sentence-terminal formality markers.

4. The system according to claim 3, wherein the circuitry is further configured to:
apply a trained classifier to the feature vector, the trained classifier outputting a probability distribution over a set of conformance categories, and
select a conformance category label corresponding to a highest probability in the probability distribution.

5. The system according to claim 4, wherein the circuitry is further configured to:
compare the conformance score with a threshold value derived from a relational attribute associated with the target entity, and
when the conformance score is below the threshold value, append to the structured input sequence an additional instruction directing the generative neural network model to increase a formality level of the output character sequence.

6. The system according to claim 1, wherein the circuitry is further configured to:
apply an affective state classifier to the input character sequence, the affective state classifier producing a probability distribution over a set of affective state labels,
store the affective state label having a highest probability together with a timestamp in a temporal buffer associated with a session identifier, and
detect, from consecutive entries in the temporal buffer, a transition between a first affective state label and a second affective state label that differs from the first affective state label.

7. The system according to claim 6, wherein, upon detecting the transition, the circuitry is further configured to:
generate an additional structured input sequence that encodes the output character sequence produced from a prior invocation of the generative neural network model, the first affective state label, and the second affective state label, and
cause the generative neural network model to produce a refined output character sequence that reflects the detected transition.

8. The system according to claim 1, wherein the circuitry is further configured to:
retrieve, from a storage device, a prompt template associated with an interaction state code, the prompt template comprising fixed instruction segments and placeholder positions, and
insert the intent classification label, a relational attribute datum, and the conformance score into the placeholder positions to form the structured input sequence.

9. The system according to claim 8, wherein the circuitry is further configured to:
compute the interaction state code by mapping a combination of the intent classification label, the conformance score, and a relational attribute category to a discrete state identifier using a stored mapping function.

10. The system according to claim 9, wherein the circuitry is further configured to:
evaluate the output character sequence against a set of conformance evaluation rules comprising a maximum permitted length, a minimum conformance score, and a prohibited token list, and
when the output character sequence fails at least one of the conformance evaluation rules, apply a transformation pipeline to the output character sequence to produce a modified output character sequence satisfying the conformance evaluation rules.

11. The system according to claim 1, wherein the circuitry is further configured to:
receive, via the packet-switched network, an audio signal from a microphone of the terminal device, and
convert the audio signal into the input character sequence by applying a speech recognition model comprising an acoustic model and a language model implemented as neural networks.

12. The system according to claim 11, wherein the circuitry is further configured to:
receive, via the packet-switched network, image frame data from an image acquisition interface of the terminal device,
apply a face detection algorithm to the image frame data to extract a normalized face region, and
apply a convolutional neural network-based expression classification model to the normalized face region to produce expression data comprising an expression label and a confidence value.

13. The system according to claim 1, wherein the circuitry is further configured to:
cause the terminal device to serialize the input character sequence and a relational attribute datum into a structured data format comprising key-value pairs, and
receive the structured data format via an encrypted transport protocol over the packet-switched network.

14. The system according to claim 13, wherein the circuitry is further configured to:
parse a response from the generative neural network model into a structured response comprising at least a generated expression field, and
serialize the structured response into the structured data format for transmission to the terminal device.

15. The system according to claim 14, wherein the circuitry is further configured to:
store, in an indexed database, an interaction record comprising the input character sequence, the structured input sequence, the output character sequence, and the conformance score, and
compute, from a plurality of stored interaction records, updated weight parameters for use in subsequent conformance score computations.

16. The system according to claim 1, wherein the circuitry is further configured to:
cause the generative neural network model to produce a plurality of candidate output character sequences, each candidate output character sequence associated with a respective conformance score, and
rank the plurality of candidate output character sequences by the respective conformance scores.

17. The system according to claim 16, wherein the circuitry is further configured to:
transmit the ranked plurality of candidate output character sequences to the terminal device,
receive, via the packet-switched network, a selection signal indicating a selected candidate output character sequence, and
store the selection signal in association with the interaction record for updating a selection preference model.

18. A system comprising:
circuitry configured to
receive, via a packet-switched network, an input character sequence and a relational attribute datum from a terminal device,
apply a natural language processing pipeline to the input character sequence to compute an intent classification label and a conformance score,
apply an affective state classifier to the input character sequence to determine an affective state label,
generate, based on the intent classification label, the conformance score, the relational attribute datum, and the affective state label, a structured input sequence for a generative neural network model,
cause the generative neural network model to produce an output character sequence representing a contextually adjusted version of the input character sequence,
detect a change in the affective state label across successive inputs within a session,
upon detecting the change, generate an additional structured input sequence encoding the output character sequence and the change, and cause the generative neural network model to produce a refined output character sequence, and
transmit, via the packet-switched network, the refined output character sequence to the terminal device for rendering on a display of the terminal device.

19. The system according to claim 18, wherein the circuitry is further configured to:
receive image frame data from an image acquisition interface of the terminal device,
apply an expression classification model to the image frame data to generate expression data indicating an emotional state of a person depicted in the image frame data, and
incorporate the expression data into the structured input sequence.

20. A method performed by a system comprising circuitry, the method comprising:
receiving, via a packet-switched network, an input character sequence from a terminal device;
applying a natural language processing pipeline to the input character sequence, the natural language processing pipeline comprising tokenization into lexical units, assignment of grammatical category labels, and construction of a syntactic dependency structure;
computing, from the syntactic dependency structure and the lexical units, an intent classification label and a conformance score indicating a degree to which the input character sequence satisfies contextual adjustment criteria associated with a target entity;
generating, based on the intent classification label and the conformance score, a structured input sequence for a generative neural network model, the structured input sequence encoding at least the input character sequence, the intent classification label, and the conformance score into a formatted instruction that causes the generative neural network model to produce an output character sequence representing a contextually adjusted version of the input character sequence; and
transmitting, via the packet-switched network, the output character sequence to the terminal device for rendering on a display of the terminal device.
